(19) United States
(12) Patent Application Publication
(10) Pub. No.: US 2025/0330695 A1
(43) Pub. Date: Oct. 23, 2025

(54) IMAGING DEVICE AND CAMERA SYSTEM

(71) Applicant: Panasonic Intellectual Property Management Co., Ltd., Osaka (JP)

(72) Inventors: HIROAKI IIJIMA, Nara (JP); MASUMI IZUCHI, Osaka (JP); JUNJI HIRASE, Osaka (JP)

(21) Appl. No.: 19/252,377

(22) Filed: Jun. 27, 2025

Related U.S. Application Data
(63) Continuation of application No. PCT/JP2023/041926, filed on Nov. 22, 2023.

(30) Foreign Application Priority Data
Jan. 18, 2023 (JP) 2023-005787

(51) Int. Cl. H04N 23/61

(52) U.S. Cl. CPC H04N 23/61

(57) ABSTRACT

An imaging device for taking an image of an object includes a photoelectric converter, a voltage supply circuit, a signal detection circuit, and a signal processing circuit. The photoelectric converter includes a first electrode, a second electrode, and a photoelectric conversion layer located between the first and second electrodes. The voltage supply circuit applies a voltage between the first and second electrodes. The signal detection circuit detects a first signal based on electric charge generated by the photoelectric converter. In a first frame period including a first period and a second period, the voltage supply circuit applies a first voltage between the first and second electrodes during the first period and applies a second voltage between the first and second electrodes during the second period. The signal processing circuit generates, based on the first signal, a second signal pertaining to a moving object moving in the first frame period.

### BACKGROUND

### 1. Technical Field

The present disclosure relates to an imaging device and a camera system.

### 2. Description of the Related Art

There have conventionally been known photoelectric conversion image sensors. For example, as image sensors, CMOS (complementary metal-oxide semiconductor) image sensors having photodiodes have been widely used. Features of the CMOS image sensors include low power consumption and pixel-by-pixel accessibility. In general, the CMOS image sensors adopt, as a signal readout method, a so-called rolling shutter method in which exposures and signal charge readouts are performed in sequence for each separate row of a pixel array.

In the rolling shutter method, the starts and ends of exposures vary from one row of the pixel array to another. Therefore, imaging an object moving at high speed may give a distorted image of the object, or using the flash may result in a difference in brightness within an image.

Under such circumstances, there is demand for a so-called global shutter function with which to start and end exposures at the same time for all pixels in the pixel array.

For example, Japanese Patent No. 6799784 discloses a method for, in a stacked image sensor whose circuit components and photoelectric converters are separate from each other, achieving a global shutter function by changing a voltage that is supplied to the photoelectric converters and thereby controlling the migration of signal charge from the photoelectric converters to charge storage regions.

Barrow, L. et al., “A QuantumFilm based QuadVGA 1.5 μm pixel image sensor with over 40% QE at 940 nm for actively illuminated applications.”, IISW, 2017, pp. 378-381 discloses a method for, by controlling a voltage that is supplied to photoelectric converters and thereby canceling out signal charge having migrated to charge storage regions, eliminating a background portion that is not actively illuminated.

Further, Japanese Unexamined Patent Application Publication No. 2020-57949 proposes an asynchronous solid imaging device called an “event-driven sensor” and a “dynamic vision sensor” that, when an amount of light received exceeds a threshold, detects it as an event for each pixel.

### SUMMARY

In one general aspect, the techniques disclosed here feature an imaging device for taking an image of an object. The imaging device includes a photoelectric converter, a voltage supply circuit, a signal detection circuit, and a signal processing circuit. The photoelectric converter includes a first electrode, a second electrode facing the first electrode, and a photoelectric conversion layer located between the first electrode and the second electrode. The voltage supply circuit applies a voltage between the first electrode and the second electrode. The signal detection circuit detects a first signal based on electric charge generated by the photoelectric converter. In a first frame period including a first period and a second period different from the first period, the voltage supply circuit applies a first voltage between the first electrode and the second electrode during the first period and applies a second voltage between the first electrode and the second electrode during the second period. The second voltage is opposite in polarity to the first voltage. The signal processing circuit generates, based on the first signal detected by the signal detection circuit in the first frame period, a second signal pertaining to a moving object moving in the first frame period.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram showing an example of a camera system according to an embodiment;

FIG. 2 is a schematic view showing an exemplary circuit configuration of an imaging element according to the embodiment;

FIG. 3 is a cross-sectional view schematically showing an exemplary device structure of each pixel according to the embodiment;

FIG. 4 is a diagram showing an example of an absorbing spectrum in a photoelectric conversion layer containing tin naphthalocyanine;

FIG. 5 is a cross-sectional view schematically showing an example of a configuration of a photoelectric conversion layer according to the embodiment;

FIG. 6 is a diagram showing an exemplary photocurrent characteristic of a photoelectric converter according to the embodiment;

FIG. 7 is a diagram for explaining an example of an operation of normal imaging driving in an imaging device according to the embodiment;

FIG. 8 is a diagram for explaining an example of an operation of moving object detection driving in the imaging device according to the embodiment;

FIG. 9 is a diagram for explaining another example of the operation of moving object detection driving in the imaging device according to the embodiment;

FIG. 10A is a diagram for explaining specific examples of the operation of moving object detection driving in the imaging device according to the embodiment and detection results;

FIG. 10B is a diagram for explaining specific examples of the operation of moving object detection driving in the imaging device according to the embodiment and detection results;

FIG. 10C is a diagram for explaining specific examples of the operation of moving object detection driving in the imaging device according to the embodiment and detection results;

FIG. 11 is a diagram for explaining a first example of drive mode switching in the imaging device according to the embodiment;

FIG. 12 is a diagram for explaining a second example of drive mode switching in the imaging device according to the embodiment;

FIG. 13 is a diagram for explaining a third example of drive mode switching in the imaging device according to the embodiment; and

FIG. 14 is a diagram for explaining pixels in which the moving object detection driving is performed and pixels in which the normal imaging driving is performed.

### DETAILED DESCRIPTIONS

An imaging device that can detect a moving object is useful.

One non-limiting and exemplary embodiment provides an imaging device and a camera system that can detect a moving object.

### Brief Overview of the Present Disclosure

As a brief overview of the present disclosure, the following gives examples of an imaging device and a camera system according to the present disclosure.

An imaging device according to a first aspect of the present disclosure is an imaging device for taking an image of an object. The imaging device includes a photoelectric converter, a voltage supply circuit, a signal detection circuit, and a signal processing circuit. The photoelectric converter includes a first electrode, a second electrode facing the first electrode, and a photoelectric conversion layer located between the first electrode and the second electrode. The voltage supply circuit applies a voltage between the first electrode and the second electrode. The signal detection circuit detects a first signal based on electric charge generated by the photoelectric converter. In a first frame period including a first period and a second period different from the first period, the voltage supply circuit applies a first voltage between the first electrode and the second electrode during the first period and applies a second voltage between the first electrode and the second electrode during the second period. The second voltage is opposite in polarity to the first voltage. The signal processing circuit generates, based on the first signal detected by the signal detection circuit in the first frame period, a second signal pertaining to a moving object moving in the first frame period.

With this, since the voltage that is applied between the first electrode and the second electrode during the first period and the voltage that is applied between the first electrode and the second electrode during the second period are opposite in polarity to each other, electric charge that is generated in the first period and electric charge that is generated in the second period cancel each other out. As a result of that, the first signal varies depending on whether an object has moved between the first period and the second period. For example, in the case of imaging of a motionless object, the first signal is small, as the difference between the quantity of electric charge that is generated in the first period and the quantity of electric charge that is generated in the second period is small. On the other hand, in the case of imaging of the moving object, the first signal is large, as the difference between the quantity of electric charge that is generated in the first period and the quantity of electric charge that is generated in the second period is large. Therefore, the signal processing circuit can generate, based on the first signal, the second signal pertaining to the moving object. Accordingly, the imaging device according to the present aspect makes it possible to detect the moving object.

Further, for example, an imaging device according to a second aspect of the present disclosure may be directed to the imaging device according to the first aspect. In the imaging device according to the second aspect, the signal processing circuit may generate image data based on the first signal, and the signal processing circuit may generate and output, as the second signal, a signal containing information indicating a portion in the image data where an amount of exposure in the image data during the first period and an amount of exposure in the image data during the second period are different from each other.

This simplifies object identification by which what the moving object is like is identified by the information indicating the portion in the image data where the amount of exposure in the image data during the first period and the amount of exposure in the image data during the second period are different from each other. For example, since the portion in the image data where the amount of exposure in the image data during the first period and the amount of exposure in the image data during the second period are different from each other serves as information pertaining to the contours of the moving object, it becomes easier to recognize the shape of the object.

Further, for example, an imaging device according to a third aspect of the present disclosure may be directed to the imaging device according to the first or second aspect. In the imaging device according to the third aspect, the signal processing circuit may detect, based on the first signal, whether the moving object is present in the image, and in a case where, in the first frame period, the signal processing circuit does not detect presence of the moving object in the image, the signal processing circuit may not generate the second signal.

This makes it possible to reduce processing in the signal processing circuit.

Further, for example, an imaging device according to a fourth aspect of the present disclosure may be directed to the imaging device according to any one of the first to third aspects. In the imaging device according to the fourth aspect, in a third period subsequent to the first period and the second period, the voltage supply circuit may apply, between the first electrode and the second electrode, a third voltage that is a voltage between the first voltage and the second voltage, and the signal detection circuit may output the first signal in the third period.

This makes it hard for the electric charge to migrate in the photoelectric converter during the third period and causes the first signal to be outputted in a state where the influence of parasitic sensitivity is small, thus simplifying detection of the moving object and object identification.

Further, for example, an imaging device according to a fifth aspect of the present disclosure may be directed to the imaging device according to the fourth aspect. In the imaging device according to the fifth aspect, the photoelectric converter may have such a photocurrent characteristic that a difference between a dark-time current and a bright-time current that flow through the photoelectric converter when the third voltage is applied between the first electrode and the second electrode is less than a difference between a dark-time current and a bright-time current that flow through the photoelectric converter when the first voltage is applied between the first electrode and the second electrode and a difference between a dark-time current and a bright-time current that flow through the photoelectric converter when the second voltage is applied between the first electrode and the second electrode.

With this, since the difference between the bright-time current and the dark-time current in the third period during which the third voltage is supplied is small, the first signal is outputted in a state where the influence of parasitic sensitivity is smaller. This further simplifies detection of the moving object and object identification.

Further, for example, an imaging device according to a sixth aspect of the present disclosure may be directed to the imaging device according to any one of the first to fifth aspects. In the imaging device according to the sixth aspect, when the second voltage is applied between the first electrode and the second electrode, a magnitude of the first signal that is detected by the signal detection circuit and inputted to the signal processing circuit may increase by light incident on the photoelectric converter, and an absolute value of the second voltage may be greater than an absolute value of the first voltage.

With this, such a second voltage for use in normal imaging is applied between the first electrode and the second electrode that the first signal increases with light incident on the photoelectric converter, whereby the sensitivity of the imaging device increases. This makes it hard for the first signal to assume a lower-limit value and further simplifies detection of the moving object.

Further, for example, an imaging device according to a seventh aspect of the present disclosure may be directed to the imaging device according to the sixth aspect. In the imaging device according to the seventh aspect, the second period may be shorter than the first period.

With this, the second period, during which the sensitivity is high, is short. This makes it easier to detect the contours of the moving object and simplifies detection of the moving object and object identification.

Further, for example, an imaging device according to an eighth aspect of the present disclosure may be directed to the imaging device according to any one of the first to seventh aspects. In the imaging device according to the eighth aspect, the imaging device may be driven by a global shutter method in which an exposure period is defined by changing the voltage that the voltage supply circuit applies between the first electrode and the second electrode.

This reduces the influence of parasitic sensitivity and brings about improvement in image quality.

Further, for example, an imaging device according to a ninth aspect of the present disclosure may be directed to the imaging device according to any one of the first to eighth aspects. The imaging device according to the ninth aspect may further include a charge accumulator in which the electric charge is stored. In the imaging device according to the ninth aspect, in the second period, a positive charge of the electric charge may be stored in the charge accumulator, and in a case where a potential of the charge accumulator is less than a threshold, the signal detection circuit may output the first signal corresponding to a value of the threshold.

With this, in a case where the potential of the charge accumulator is less than the threshold, the first signal thus outputted is constant. This makes it possible to reduce processing in the signal processing circuit.

Further, for example, an imaging device according to a tenth aspect of the present disclosure may be directed to the imaging device according to any one of the first to ninth aspects. In the imaging device according to the tenth aspect, the signal processing circuit may detect, based on the first signal, whether the moving object is present in the image, and in a case where presence of the moving object in the image is detected by the signal processing circuit in the first frame period, the voltage supply circuit may not apply the first voltage between the first electrode and the second electrode and may apply a fourth voltage between the first electrode and the second electrode during a one-frame period subsequent to the first frame period, the fourth voltage being identical in polarity to the second voltage.

With this, in a case where the presence of the moving object in the image is detected, a voltage of one polarity is applied between the first electrode and the second electrode to enable normal imaging, making it possible to output, from the imaging device, image data that makes it easier for a user or other persons to identify the moving object.

Further, for example, an imaging device according to an eleventh aspect of the present disclosure may be directed to the imaging device according to any one of the first to tenth aspects. In the imaging device according to the eleventh aspect, the signal processing circuit may identify a shape of the moving object based on the first signal and may generate and output, as the second signal, a signal containing information indicating the shape.

This makes it possible to reduce the processing load of the second signal in post-processing. Further, for example, this makes it possible to reduce power consumption of an overall system including the imaging device. Further, this enables considerations for privacy and object recognition.

Further, for example, an imaging device according to a twelfth aspect of the present disclosure may be directed to the imaging device according to any one of the first to tenth aspects. In the imaging device according to the twelfth aspect, the signal processing circuit may generate and output, as the second signal, a signal containing binarized or ternarized image data.

This makes it possible to reduce the processing load of the second signal in post-processing. Further, for example, this makes it possible to reduce power consumption of an overall system including the imaging device. Further, this makes it possible to reduce the volume of saved data.

Further, for example, an imaging device according to a thirteenth aspect of the present disclosure may be directed to the imaging device according to any one of the first to tenth aspects. In the imaging device according to the thirteenth aspect, the signal processing circuit may generate and output, as the second signal, a signal containing image data from which information indicating an object other than the moving object is decimated.

This makes it possible to reduce the processing load of the second signal in post-processing. Further, for example, this makes it possible to reduce power consumption of an overall system including the imaging device. Further, this makes it possible to reduce the volume of saved data. Further, a background that is not moving or other parts can be eliminated from the image data without post-processing, and only the moving object is detected. This makes it easier to detect a moving object such as a suspicious person in a surveillance application or other applications.

Further, for example, an imaging device according to a fourteenth aspect of the present disclosure may be directed to the imaging device according to any one of the first to thirteenth aspects. The imaging device according to the fourteenth aspect may further include a drive control circuit that controls driving of the imaging device. In the imaging device according to the fourteenth aspect, the drive control circuit may control the imaging device so that the imaging device switches between performing (i) moving object detection driving in which in the first frame period, the signal processing circuit generates the second signal pertaining to the moving object and performing (ii) normal imaging driving in which in a second frame period, the voltage supply circuit does not apply the first voltage between the first electrode and the second electrode and applies a fourth voltage between the first electrode and the second electrode, the fourth voltage being identical in polarity to the second voltage.

This enables switching between performing the detection of the moving object and the taking of a normal image, and appropriate switching of driving of the imaging device by the drive control circuit makes it possible to reduce the volume of images that are saved. Further, for example, this makes it possible to reduce power consumption of an overall system including the imaging device.

Further, for example, an imaging device according to a fifteenth aspect of the present disclosure may be directed to the imaging device according to the fourteenth aspect. In the imaging device according to the fifteenth aspect, the signal processing circuit may detect, based on the first signal, whether the moving object is present in the image, and in a case where presence of the moving object in the image is detected by the signal processing circuit while the imaging device is performing the moving object detection driving, the drive control circuit may switch from the moving object detection driving to the normal imaging driving.

With this, for example, an overall system including the imaging device detects the moving object in a power-saving and capacity-saving manner, and after the moving object has been detected, a more detailed image can be obtained by the normal imaging driving.

Further, for example, an imaging device according to a sixteenth aspect of the present disclosure may be directed to the imaging device according to the fifteenth aspect. In the imaging device according to the sixteenth aspect, the drive control circuit may switch from the normal imaging driving to the moving object detection driving after a predetermined period of time has elapsed since switching to the normal imaging driving was done.

With this, normal imaging is performed only for a predetermined period of time since the moving object was detected. This makes it possible, for example, to reduce power consumption of an overall system including the imaging device.

Further, for example, an imaging device according to a seventeenth aspect of the present disclosure may be directed to the imaging device according to the fourteenth aspect. In the imaging device according to the seventeenth aspect, the signal processing circuit may detect, based on the first signal, whether the moving object is present in the image, and in a case where presence of the moving object is detected by the signal processing circuit while the imaging device is performing the moving object detection driving, the drive control circuit may cause the moving object detection driving and the normal imaging driving to be repeatedly performed until the presence of the moving object is no longer detected by the signal processing circuit.

With this, normal image acquisition is performed until the moving object is no longer detected. This makes it possible to output, from the imaging device, image data that makes it easier for a user or other persons to identify the moving object.

Further, for example, an imaging device according to an eighteenth aspect of the present disclosure may be directed to the imaging device according to any one of the fourteenth to seventeenth aspects. The imaging device according to the eighteenth aspect may further include a plurality of pixels. In the imaging device according to the eighteenth aspect, each of the plurality of pixels may include the photoelectric converter and the signal detection circuit, the plurality of pixels may include a first pixel group in which the moving object detection driving is performed and a second pixel group in which the normal imaging driving is performed, and the number of pixels in the first pixel group may be less than the number of pixels in the second pixel group.

This enables driving with lower power consumption in the moving object detection driving.

Further, for example, an imaging device according to a nineteenth aspect of the present disclosure may be directed to the imaging device according to any one of the fourteenth to eighteenth aspects. In the imaging device according to the nineteenth aspect, in the moving object detection driving, the second signal may not be outputted to a device external to the imaging device.

This makes it possible to reduce power consumption. Further, this makes it possible to reduce the processing load of the second signal in post-processing.

Further, a camera system according to a twentieth aspect of the present disclosure includes the imaging device according to any one of the first to nineteenth aspects and a lighting device that emits light containing near infrared radiation.

This makes it possible to detect a moving object even in a state such as nighttime where the moving object becomes invisible to a human eye.

The following describes the present embodiment in concrete terms with reference to the drawings.

It should be noted that the embodiments to be described below each illustrate a comprehensive and specific example. The numerical values, shapes, materials, constituent elements, placement and topology of constituent elements, steps, orders of steps, or other features that are shown in the following embodiments are just a few examples and are not intended to limit the present disclosure. Further, those of the constituent elements in the following embodiments which are not recited in an independent claim are described as optional constituent elements. Further, the drawings are not necessarily strict illustrations. Further, in the drawings, substantially the same components are given the same reference signs, and a repeated description may be omitted or simplified.

Further, terms used herein to show the way in which elements are interrelated, terms used herein to show the shape of an element, and ranges of numerical values used herein are not expressions that represent only exact meanings but expressions that are meant to also encompass substantially equivalent ranges, e.g. differences of approximately several percent.

Further, the terms “above” and “below” used herein do not refer to an upward direction (upward in a vertical direction) and a downward direction (downward in a vertical direction) in absolute space recognition, but are used as terms that are defined by a relative positional relationship on the basis of an order of stacking in a stack configuration. Specifically, the term “above” refers to a light receiving side of an imaging device, and the term “below” refers to a side of the imaging device that faces away from the light receiving side. It should be noted that terms such as “above” and “below” are used solely to designate the mutual placement of members and are not intended to limit the attitude of the imaging device during use. Further, the terms “above” and “below” are applied not only in a case where two constituent elements are placed at a spacing from each other and another constituent element is present between the two constituent elements, but also in a case where two constituent elements are placed in close contact with each other and the two constituent elements touch each other.

### Embodiment

The following describes an imaging device and a camera system according to the embodiment.

### Camera System

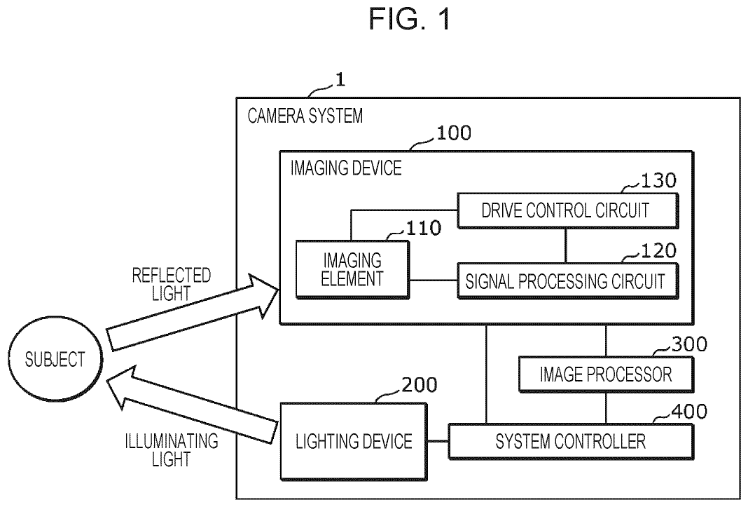

First, a camera system according to the present embodiment is described. FIG. 1 is a block diagram showing an example of a camera system 1 according to the present embodiment.

As shown in FIG. 1, the camera system 1 includes an imaging device 100, a lighting device 200, an image processor 300, and a system controller 400.

In the camera system 1, ambient light and illuminating light emitted by the lighting device 200 are reflected off a subject, and the resulting reflected light is taken out as an electrical signal by being converted into electric charge by a photoelectric converter of the imaging device 100. It should be noted that in a case where ambient light such as sunlight or exterior lighting is used for imaging, the camera system 1 does not need to include the lighting device 200.

The imaging device 100 includes an imaging element 110, a signal processing circuit 120, and a drive control circuit 130. The imaging element 110 includes the after-mentioned photoelectric converter and output a signal based on light falling on the photoelectric converter. The signal processing circuit 120 performs signal processing on a signal outputted from the imaging element 110. The drive control circuit 130 controls how the imaging device 100 (particularly the imaging element 110) operates. The signal processing circuit 120 and the drive control circuit 130 are implemented, for example, as one or more microcomputers or processors containing programs for performing processes in the signal processing circuit 120 and the drive control circuit 130, respectively. Alternatively, the signal processing circuit 120 and the drive control circuit 130 may each be implemented, for example, as separate microcomputers or processors or may each be implemented, for example, as one microcomputer or processor. The signal processing circuit 120 and the drive control circuit 130 may include dedicated logic circuits for performing processes in the signal processing circuit 120 and the drive control circuit 130, respectively. The imaging device 100 will be described in detail later.

For example, the lighting device 200 emits, as illuminating light, light containing near infrared radiation. In this case, the light containing near infrared radiation is converted into electric charge by a photoelectric converter of the imaging device 100 that has sensitivity to a near-infrared wavelength and taken out as an electrical signal. A wavelength region of near infrared radiation contained in the illuminating light is, for example, longer than or equal to 680 nm and shorter than or equal to 3000 nm. Alternatively, the wavelength region of near infrared radiation contained in the illuminating light may be longer than or equal to 700 nm and shorter than or equal to 2000 nm or may be longer than or equal to 700 nm and shorter than or equal to 1600 nm. It should be noted that the illuminating light does not need to contain near infrared radiation but may contain at least either visible light or ultraviolet radiation.

Any type of light source may be used in the lighting device 200 as long as the light source can emit light of a desired wavelength. The light source that is used in the lighting device 200 may be, for example, a halogen light source, an LED (light-emitting diode) light source, an organic EL (electroluminescence) light source, a laser diode light source, or other light sources. Further, with the light source that is used in the lighting device 200, a plurality of light sources differing in luminous wavelength from each other may be combined for use. Further, a usable example of a light source that emits light containing near infrared radiation is an inexpensive LED having a peak wavelength longer than or equal to 820 nm and shorter than or equal to 980 nm.

The image processor 300 is a processing circuit that performs various processes on output signals containing image data or other data outputted from the imaging device 100. The image processor 300 performs processes such as gamma correction, color interpolation, spatial interpolation, auto white balance, distance measurement and calculation, and wavelength information separation. For example, the image processor 300 processes output signals from the imaging device 100 and outputs them as images to an external device. The image processor 300 is implemented, for example, as one or more microcomputers or processors containing a program for performing processes in the image processor 300. The image processor 300 may include a dedicated logic circuit for performing processes in the image processor 300. A specific example of the image processor 300 is an ISP (image signal processor).

The system controller 400 exercises overall control of the camera system 1. The system controller 400 controls, for example, the timing of imaging by the imaging device 100 and the timing of emission of the illuminating light by the lighting device 200. The system controller 400 is implemented, for example, as one or more microcomputers or processors containing a program for performing processes in the system controller 400. The system controller 400 may include a dedicated logic circuit for performing processes in the system controller 400.

Further, the system controller 400 may drive the lighting device 200 to emit light in a period overlapping at least part of both the after-mentioned exposure and counter-exposure periods. This can cause the lighting device 200 to emit light only during the exposure and counter-exposure periods of the imaging device 100, making it possible to extend the life of the lighting device 200 and save energy.

Although, in the example shown in FIG. 1, the imaging device 100, the lighting device 200, the image processor 300, and the system controller 400 are shown as separate functional blocks, two or more of the imaging device 100, the lighting device 200, the image processor 300, and the system controller 400 may be integrated, for example, by being provided in an identical housing. Further, the image processor 300 and the system controller 400 may each be implemented, for example, as separate microcomputers or processors or may each be implemented, for example, as one microcomputer or processor.

Further, at least some functions of the image processor 300 and the system controller 400 may be possessed by the imaging device 100. For example, at least either the image processor 300 or the system controller 400 may be provided in the imaging device 100. Further, in this case, the signal processing circuit 120, the drive control circuit 130, the image processor 300, and the system controller 400 may each be implemented, for example, as separate microcomputers or processors, and the functions of two or more of them may be implemented, for example, as one microcomputer or processor.

### Imaging Element

Next, the imaging element 110 of the imaging device 100 according to the present embodiment is described in detail.

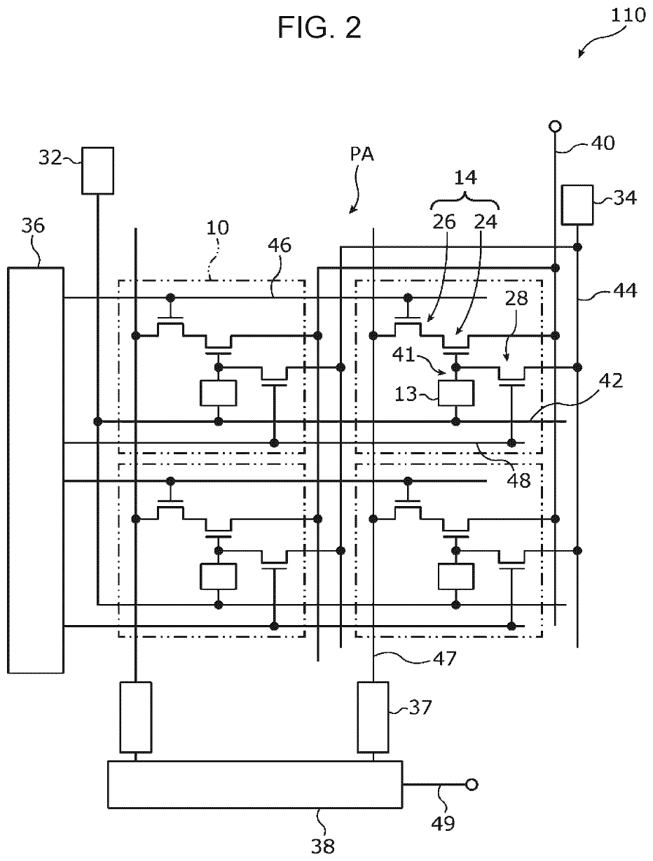

FIG. 2 is a schematic view showing an exemplary circuit configuration of the imaging element 110 according to the present embodiment.

As shown in FIG. 2, the imaging element 110 includes a pixel array PA and peripheral circuits. The pixel array PA includes a plurality of pixels 10 arrayed two-dimensionally, and the peripheral circuits have connections to each pixel 10. The peripheral circuits include, for example, a voltage supply circuit 32, a reset voltage source 34, a vertical scanning circuit 36, column signal processing circuits 37, and a horizontal signal readout circuit 38. FIG. 2 schematically shows an example in which the pixels 10 are arranged in two rows and two columns in a matrix. The number and arrangement of pixels 10 in the imaging element 110 are not limited to the example shown in FIG. 2.

Each pixel 10 has a photoelectric converter 13 and a signal detection circuit 14. As will be described later with reference to the drawings, the photoelectric converter 13 has a photoelectric conversion layer sandwiched between two electrodes facing each other and generates electric charge upon receiving incident light. The photoelectric converter 13 does not need to be an element that is independent in its entirety for each pixel 10, and for example, a portion of the photoelectric converter 13 may lie astride a plurality of pixels 10.

The signal detection circuit 14 is a circuit that detects a pixel signal in the pixel 10 such as a signal based on electric charge generated by the photoelectric converter 13. The pixel signal is an example of a first signal. In the example shown in FIG. 2, the signal detection circuit 14 includes a signal detection transistor 24 and an address transistor 26. The signal detection transistor 24 and the address transistor 26 are, for example, field-effect transistors (FETs). As the signal detection transistor 24 and the address transistor 26, N-channel MOSFETs (metal-oxide semiconductor field-effect transistors) are illustrated here. Each transistor such as the signal detection transistor 24, the address transistor 26, and the after-mentioned reset transistor 28 has a control terminal, an input terminal, and an output terminal. The control terminal is, for example, a gate. The input terminal is one of a drain and a source and is, for example, the drain. The output terminal is the other of the drain and the source and is, for example, the source.

As schematically shown in FIG. 2, the control terminal of the signal detection transistor 24 has an electrical connection to the photoelectric converter 13. The electric charge generated by the photoelectric converter 13 is stored in a charge storage node 41 between the gate of the signal detection transistor 24 and the photoelectric converter 13. The electric charge here is a hole and an electron. The charge storage node 41 is also called a “floating diffusion node”. The charge storage node 41 is at least part of a charge storage region that is an example of a charge accumulator in which the electric charge generated by the photoelectric converter 13 is stored. A structure of the photoelectric converter 13 will be described in detail later.

The photoelectric converter 13 of each pixel 10 further has a connection to a sensitivity control line 42. In the configuration illustrated in FIG. 2, the sensitivity control line 42 is connected to the voltage supply circuit 32. The voltage supply circuit 32 is also called a “sensitivity control voltage supply circuit”. The voltage supply circuits 32 is a circuit configured to be able to supply at least three types of voltage. The voltage supply circuit 32 supplies a predetermined voltage to the photoelectric converter 13 via the sensitivity control line 42 during operation of the imaging element 110. The voltage supply circuit 32 is not limited to particular power supply circuits but may be a circuit that generates a predetermined voltage or may be a circuit that converts a voltage supplied from another power supply into a predetermined voltage. As will be described in detail later, by switching, between a plurality of voltages differing from each other, the voltage that is supplied from the voltage supply circuit 32 to the photoelectric converter 13, the start and end of storage of the electric charge from the photoelectric converter 13 into the charge storage node 41 are controlled. In other words, in the present embodiment, an electronic shutter operation is executed by switching the voltage that is supplied from the voltage supply circuit 32 to the photoelectric converter 13. Further, by switching, between a plurality of voltages differing from each other (e.g. between voltages differing in polarity from each other), the voltage that is supplied from the voltage supply circuit 32 to the photoelectric converter 13, the polarity of the electric charge that is stored in the charge storage node 41 can be changed. An example of operation of the imaging element 110 will be described later.

Each pixel 10 has a connection to a power wire 40 through which a power supply voltage VDD is supplied. As shown in FIG. 2, to the power wire 40, the input terminal of the signal detection transistor 24 is connected. The functioning of the power wire 40 as a source follower power supply causes the signal detection transistor 24 to amplify and output a signal corresponding to the electric charge generated by the photoelectric converter 13.

To the output terminal of the signal detection transistor 24, the input terminal of the address transistor 26 is connected. The output terminal of the address transistor 26 is connected to one of a plurality of vertical signal lines 47 placed separately for each of the rows of the pixel array PA. The control terminal of the address transistor 26 is connected to an address control line 46. By controlling the potential of the address control line 46, output from the signal detection transistor 24 can be selectively read out to a corresponding one of the vertical signal lines 47.

In the example shown in FIG. 2, the address control line 46 is connected to the vertical scanning circuit 36. The vertical scanning circuit 36 is also called a “row scanning circuit”. The vertical scanning circuit 36 applies a predetermined voltage to the address control line 46 and thereby selects, on a row-by-row basis, a plurality of pixels 10 arranged in each row. In this way, the reading out of signals from the pixels 10 thus selected and the resetting of the charge storage regions of the pixels 10 thus selected and the after-mentioned pixel electrodes are executed.

The vertical signal lines 47 are main signal lines through which pixel signals from the pixel array PA are transmitted to the peripheral circuits. To the vertical signal lines 47, the column signal processing circuits 37 are connected. The column signal processing circuits 37 are also called “row signal storage circuits”. The column signal processing circuits 37 each perform, for example, noise suppression signal processing typified by correlated double sampling and analog-to-digital conversion (AD conversion). As shown in FIG. 2, the column signal processing circuits 37 are provided separately in correspondence with each of the rows of pixels 10 in the pixel array PA. To these column signal processing circuits 37, the horizontal signal readout circuit 38 is connected. The horizontal signal readout circuit 38 is also called a “column scanning circuit”. The horizontal signal readout circuit 38 sequentially reads out signals from the plurality of column signal processing circuits 37 to a horizontal common signal line 49.

In the configuration illustrated in FIG. 2, each of the pixels 10 has a reset transistor 28. The reset transistor 28 can be, for example, a field-effect transistor as is the case with the signal detection transistor 24 and the address transistor 26. Unless otherwise noted, the following describes an example in which an N-channel MOSFET is applied as the reset transistor 28.

As shown in FIG. 2, the reset transistor 28 is connected between a reset voltage line 44 that supplies a reset voltage Vr and the charge storage node 41. The control terminal of the reset transistor 28 is connected to a reset control line 48. By controlling the potential of the reset control line 48, the potential of the charge storage region including the charge storage node 41 can be reset to the reset voltage Vr. In this example, the reset control line 48 is connected to the vertical scanning circuit 36. Accordingly, the application of a predetermined voltage to the reset control line 48 by the vertical scanning circuit 36 makes it possible to reset, on a row-by-row basis, a plurality of pixels 10 arranged in each row.

In this example, the reset voltage line 44, which supplies the reset voltage Vr to the reset transistor 28, is connected to the reset voltage source 34. The reset voltage source 34 is also called a “reset voltage supply circuit”. The reset voltage source 34 needs only be configured to be able to supply the predetermined reset voltage Vr to the reset voltage line 44 during operation of the imaging element 110 and, as is the case with the aforementioned voltage supply circuit 32, is not limited to particular power supply circuits. The voltage supply circuit 32 and the reset voltage source 34 may each be a portion of a single voltage supply circuit, or may each be an independent and separate voltage supply circuit. It should be noted that either or both of the voltage supply circuit 32 and the reset voltage source 34 may be a portion of the vertical scanning circuit 36. Alternatively, a sensitivity control voltage from the voltage supply circuit 32 and/or the reset voltage Vr from the reset voltage source 34 may be supplied to each pixel 10 via the vertical scanning circuit 36.

It is also possible to use the power supply voltage VDD of the signal detection circuit 14 as the reset voltage Vr. In this case, commonality can be achieved between a voltage supply circuit (not illustrated in FIG. 2) that supplies a power supply voltage to each pixel 10 and the reset voltage source 34. Further, commonality can be achieved between the power wire 40 and the reset voltage line 44, so that wiring in the pixel array PA can be simplified. Note, however, that using different voltages as the reset voltage Vr and the power supply voltage VDD of the signal detection circuit 14 allows more flexibility in control of the imaging element 110.

### Device Structure of Pixel

Next, a cross-section structure of each of the pixels 10 of the imaging element 110 according to the present embodiment is described.

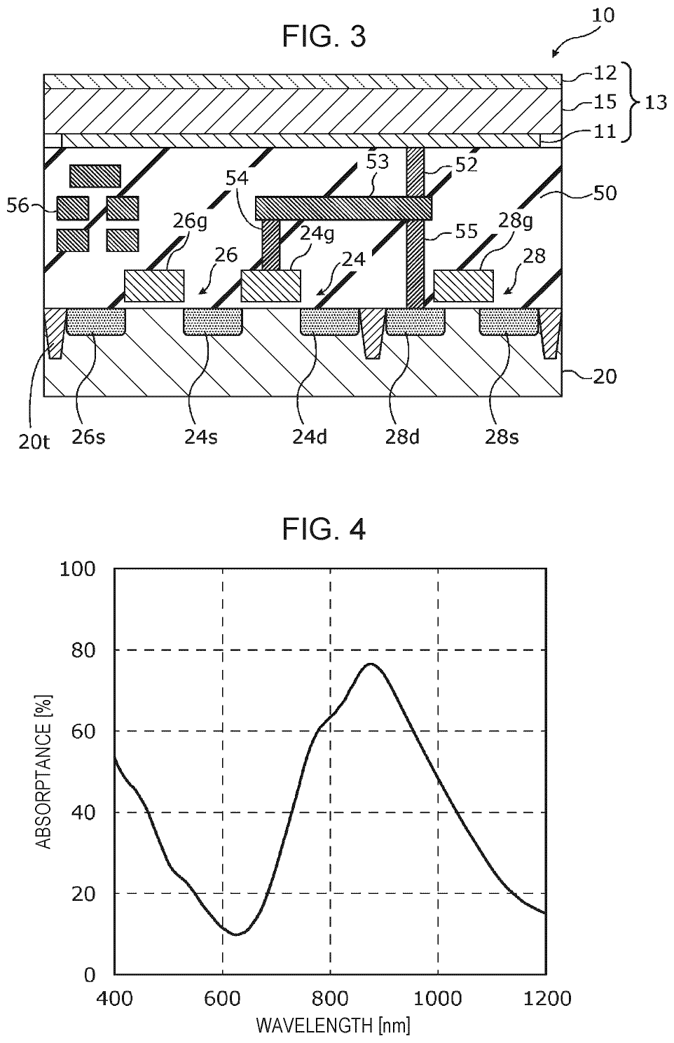

FIG. 3 is a cross-sectional view schematically showing an exemplary device structure of each of the pixels 10 according to the present embodiment. In the configuration illustrated in FIG. 3, the aforementioned signal detection transistor 24, address transistor 26, and reset transistor 28 are formed in a semiconductor substrate 20. The semiconductor substrate 20 is not limited to a substrate made entirely of a semiconductor. The semiconductor substrate 20 may be an insulating substrate having a semiconductor layer provided on a surface thereof at which a photosensitive region is formed. An example is described here in which a P-type silicon (Si) substrate is used as the semiconductor substrate 20.

The semiconductor substrate 20 has impurity regions 26s, 24s, 24d, 28d, and 28s and a device isolation region 20t that provides electrical isolation between pixels 10. The impurity regions 26s, 24s, 24d, 28d, and 28s here are N-type regions. Further, the device isolation region 20t is also provided between the impurity region 24d and the impurity region 28d. The device isolation region 20t is formed, for example, by performing ion implantation of an acceptor under predetermined implantation conditions.

The impurity regions 26s, 24s, 24d, 28d, and 28s are, for example, diffusion layers formed in the semiconductor substrate 20. As schematically shown in FIG. 3, the signal detection transistor 24 includes the impurity regions 24s and 24d and a gate electrode 24g. The impurity region 24s functions, for example, as a source region of the signal detection transistor 24. The impurity region 24d functions, for example, as a drain region of the signal detection transistor 24. The signal detection transistor 24 has its channel region formed between the impurity regions 24s and 24d.

Similarly, the address transistor 26 includes the impurity regions 26s and 24s and a gate electrode 26g connected to the address control line 46 (see FIG. 2). In this example, the signal detection transistor 24 and the address transistor 26 are electrically connected to each other by sharing the impurity region 24s. The impurity region 26s functions, for example, as a source region of the address transistor 26. The impurity region 26s has a connection to the vertical signal line 47 (see FIG. 2), which is not illustrated in FIG. 3.

The reset transistor 28 includes the impurity regions 28d and 28s and a gate electrode 28g connected to the reset control line 48 (see FIG. 2). The impurity region 28s functions, for example, as a source region of the reset transistor 28. The impurity region 28s has a connection to the reset voltage line 44 (see FIG. 2), which is not illustrated in FIG. 3. The impurity region 28d functions, for example, as a drain region of the reset transistor 28.

The gate electrodes 24g, 26g, and 28g are each made of a conducting material. The conducting material is, for example, polysilicon rendered conductive by being doped with an impurity, but may be a metal material.

An interlayer insulating layer 50 is placed over the semiconductor substrate 20 so as to cover the signal detection transistor 24, the address transistor 26, and the reset transistor 28. The interlayer insulating layer 50 is made, for example, of an insulating material such as silicon oxide. As shown in FIG. 3, a wiring layer 56 can be placed in the interlayer insulating layer 50. The wiring layer 56 is made, for example, of metal such as copper. The wiring layer 56 can include, for example, a wire such as the aforementioned vertical signal lines 47 as part thereof. The number of insulating layers in the interlayer insulating layer 50 and the number of layers included in the wiring layer 56 placed in the interlayer insulating layer 50 may be arbitrarily set and are not limited to the example shown in FIG. 3.

The aforementioned photoelectric converter 13 is placed over the interlayer insulating layer 50. In other words, in the present embodiment, the plurality of pixels 10, which constitute the pixel array PA (see FIG. 2), are formed over the semiconductor substrate 20. The plurality of pixels 10, which are arrayed two-dimensionally over the semiconductor substrate 20, form a photosensitive region serving as a pixel region. The distance between two adjacent pixels 10 can be, for example, approximately 2 μm. The distance between two adjacent pixels 10 is also called a “pixel pitch”.

The photoelectric converter 13 includes a pixel electrode 11, a counter electrode 12, and a photoelectric conversion layer 15 placed between the pixel electrode 11 and the counter electrode 12. The pixel electrode 11 is an example of a first electrode, and the counter electrode 12 is an example of a second electrode. In this example, the counter electrode 12 and the photoelectric conversion layer 15 are formed across the plurality of pixels 10. On the other hand, the pixel electrode 11 is provided for each pixel 10 and, by being spatially isolated from the pixel electrode 11 of an adjacent pixel 10, is electrically isolated from the pixel electrode 11 of the adjacent pixel 10.

The counter electrode 12 is placed opposite the pixel electrode 11 with the photoelectric conversion layer 15 sandwiched therebetween. The counter electrode 12 is, for example, a transparent electrode made of a transparent conducting material. The counter electrode 12 is placed, for example, on a side of the photoelectric conversion layer 15 on which light falls. Accordingly, on the photoelectric conversion layer 15, light having passed through the counter electrode 12 falls. Light that is detected by the imaging element 110 is not confined to light falling within a visible light wavelength range (e.g. 380 nm to 780 nm). The term “transparent” herein means transmitting at least part of light in a wavelength range to be detected, and it is not essential to transmit light across the whole wavelength range of visible light. All electromagnetic waves including visible light, infrared radiation, and ultraviolet radiation are herein expressed as “light” for convenience. The counter electrode 12 may be made, for example, of a transparent conducting oxide (TCO) such as ITO, IZO, AZO, FTO, SnO₂, TiO₂, or ZnO₂.

The photoelectric conversion layer 15 generates a hole-electron pair as a charge pair upon receiving incident light. The photoelectric conversion layer 15 is made, for example, of an organic material. Specific examples of the material of which the photoelectric conversion layer 15 is made will be described later.

As described with reference to FIG. 2, the counter electrode 12 has a connection to the sensitivity control line 42, which is connected to the voltage supply circuit 32. Further, in this example, the counter electrode 12 is formed across the plurality of pixels 10. This enables the voltage supply circuit 32 to apply a sensitivity control voltage of desired magnitude across the plurality of pixels 10 en bloc via the sensitivity control line 42. As long as a sensitivity control voltage of desired magnitude can be applied from the voltage supply circuit 32, the counter electrode 12 may be provided separately for each of the pixels 10. Similarly, the photoelectric conversion layer 15 may be provided separately for each of the pixels 10.

The voltage supply circuit 32 applies a voltage between the pixel electrode 11 and the counter electrode 12 by supplying a voltage to the counter electrode 12. As will be described in detail later, the voltage supply circuit 32 supplies, to the counter electrode 12, voltages differing from one another among an exposure period, a non-exposure period, and a counter-exposure period. The term “exposure period” herein means a period during which to store, in the charge storage region, signal charge of a first polarity, i.e. electric charge that is either positive or negative charge generated by photoelectric conversion, and may be called a “charge storage period”. The term “counter-exposure period” means a period during which to store, in the charge storage region, signal charge of a second polarity opposite to the first polarity, i.e. electric charge that is opposite in polarity to the electric charge generated by photoelectric conversion and stored in the charge storage region in the “exposure period”. Therefore, the “exposure period” and the “counter-exposure period” have such a relationship that the electric charge that is stored in the charge storage region during the “exposure period” and the electric charge that is stored in the charge storage region during the “counter-exposure period” cancel each other out. Further, a period during which to store electric charge in the charge storage region can also be said to be a period during which to cause the electric charge to migrate to the charge storage region.

Further, the “exposure period” is, for example, a period in which a luminance value in image data that is outputted from the imaging element 110 by light falling on the photoelectric converter 13 increases, i.e., in which an image turns white. In this case, the “counter-exposure period”, which is a period during which to store electric charge that cancels out the electric charge that is stored during the “exposure period”, is a period in which a luminance value in image data that is outputted from the imaging element 110 by light falling on the photoelectric converter 13 decreases, i.e., in which an image turns black.

Further, the term “non-exposure period” means a period during operation of the imaging device excluding the exposure period and the counter-exposure period. It should be noted that the “non-exposure period” is not limited to a period during which light is blocked from falling on the photoelectric converter 13, but may include a period during which the photoelectric converter 13 is illuminated with light. Further, the “non-exposure period” includes a period during which electric charge is unintentionally stored in the charge storage region due to the occurrence of parasitic sensitivity.

By controlling the potential of the counter electrode 12 in relation to the potential of the pixel electrode 11, i.e. the voltage that is applied between the pixel electrode 11 and the counter electrode 12, electric charge that is either the hole or electron of a hole-electron pair generated in the photoelectric conversion layer 15 by photoelectric conversion can be collected by the pixel electrode 11. The voltage that is applied between the pixel electrode 11 and the counter electrode 12 is also referred to as a “bias voltage”. The electric charge collected by the pixel electrode 11 is stored in the charge storage region. For example, in a case where the hole is collected as the electric charge, the hole can be selectively collected by the pixel electrode 11 by making the counter electrode 12 higher in potential than the pixel electrode 11. Alternatively, for example, in a case where the electron is collected as the electric charge, the electron can be selectively collected by the pixel electrode 11 by making the counter electrode 12 lower in potential than the pixel electrode 11. The following illustrates a case where in a case where the pixel electrode 11 collects the hole as the electric charge, the magnitude of a signal that is detected by the signal detection circuit 14 and inputted to the signal processing circuit 120 increases. That is, the hole is utilized as the electric charge for use in normal imaging, and during the exposure period, the hole is collected by the pixel electrode 11 and stored in the charge storage region. Aa a matter of course, such a design can be adopted that in a case where the pixel electrode 11 collects the electron as the electric charge, the magnitude of a signal that is detected by the signal detection circuit 14 and inputted to the signal processing circuit 120 increases. In this case, the electron is utilized as the electric charge for use in normal imaging, and during the exposure period, the electron is collected by the pixel electrode 11 and stored in the charge storage region.

In the presence of the application of an appropriate bias voltage between the counter electrode 12 and the pixel electrode 11 as mentioned above, the pixel electrode 11, which faces the counter electrode 12, collects either positive or negative charge generated by photoelectric conversion in the photoelectric conversion layer 15. The pixel electrode 11 is made, for example, of metal such as aluminum or copper, a metal nitride, polysilicon rendered conductive by being doped with an impurity, or other materials.

The pixel electrode 11 may be a light-blocking electrode. For example, a sufficient light blocking effect can be achieved by forming, as the pixel electrode 11, a TaN electrode whose thickness is 100 nm. When the pixel electrode 11 is a light-blocking electrode, light having passed through the photoelectric conversion layer 15 can be inhibited from falling on the channel region or impurity regions of a transistor formed in the semiconductor substrate 20 (in this example, at least any of the signal detection transistor 24, the address transistor 26, and the reset transistor 28). The aforementioned wiring layer 56 may be utilized to form a light-blocking film in the interlayer insulating layer 50. By inhibiting light from falling on the channel region of a transistor formed in the semiconductor substrate 20, a shift in the characteristic of the transistor (e.g. a fluctuation in threshold voltage) or other changes can be inhibited. Further, by inhibiting light from falling on an impurity region formed in the semiconductor substrate 20, noise contamination by unintended photoelectric conversion in the impurity region can be inhibited. Thus, inhibiting light from falling on the semiconductor substrate 20 contributes to improvement in reliability of the imaging element 110.

As schematically shown in FIG. 3, the pixel electrode 11 is connected to the gate electrode 24g of the signal detection transistor 24 via the plug 52, a wire 53, and a contact plug 54. In other words, the gate of the signal detection transistor 24 has an electrical connection to the pixel electrode 11. The plug 52 and the wire 53 are made, for example, of metal such as copper. The plug 52, the wire 53, and the contact plug 54 constitute at least part of the charge storage node 41 (see FIG. 2) between the signal detection transistor 24 and the photoelectric converter 13. The wire 53 can be part of the wiring layer 56. Further, the pixel electrode 11 is also connected to the impurity region 28d via the plug 52, the wire 53, and a contact plug 55. In the configuration illustrated in FIG. 2, the gate electrode 24g of the signal detection transistor 24, the plug 52, the wire 53, the contact plugs 54 and 55, and the impurity region 28d, which is one of the source region and the drain region of the reset transistor 28, function as a charge storage region in which to store electric charge collected by the pixel electrode 11.

The collection of electric charge by the pixel electrode 11 causes a voltage corresponding to the quantity of electric charge stored in the charge storage region to be applied to the gate of the signal detection transistor 24. The voltage that is applied to the gate of the signal detection transistor 24 corresponds to the potential of the charge storage node 41. The signal detection transistor 24 amplifies this voltage. The voltage amplified by the signal detection transistor 24 is selectively read out as a signal voltage via the address transistor 26.

It should be noted that at least one of each circuit of the peripheral circuits of the aforementioned imaging element 110, the signal processing circuit 120, and the drive control circuit 130 may be formed in the same semiconductor substrate 20 as the imaging element 110.

### Example of Configuration of Photoelectric Conversion Layer

Next, the photoelectric conversion layer 15 is described in detail.

As mentioned above, by illuminating the photoelectric conversion layer 15 with light and applying a bias voltage between the pixel electrode 11 and the counter electrode 12, either positive or negative charge generated by photoelectric conversion is collected by the pixel electrode 11, and the electric charge thus collected can be stored in the charge storage region. By using a photoelectric converter 13 having a photoelectric conversion layer 15 that exhibits a photocurrent characteristic such as that described below and reducing the potential difference between the pixel electrode 11 and the counter electrode 12 to a certain degree, the electric charge already stored in the charge storage region can be inhibited from migrating to the counter electrode 12 via the photoelectric conversion layer 15. Furthermore, further migration of electric charge into the charge storage region after the reduction of the potential difference can be inhibited. That is, by controlling the magnitude of a bias voltage that is applied to the photoelectric converter 13, a global shutter function can be achieved without separately providing each of the plurality of pixels 10 with an element such as a transfer transistor as in the case of a technology described in Japanese Patent No. 6799784. An example of operation in the imaging device 100 will be described later. Further, as a matter of course, normal rolling shutter driving is enabled by holding constant the magnitude of a bias voltage that is applied to the photoelectric converter 13 and starting the exposure period upon completion of resetting of the pixel 10.

The following describes an example of a configuration of the photoelectric conversion layer 15.

The photoelectric conversion layer 15 contains, for example, a semiconductor material. In the present embodiment, for example, an organic semiconductor material is used as the semiconductor material.

The photoelectric conversion layer 15 contains, for example, tin naphthalocyanine represented by general formula (1) below. In the following, the tin naphthalocyanine represented by general formula (1) below is sometimes simply called “tin naphthalocyanine”.

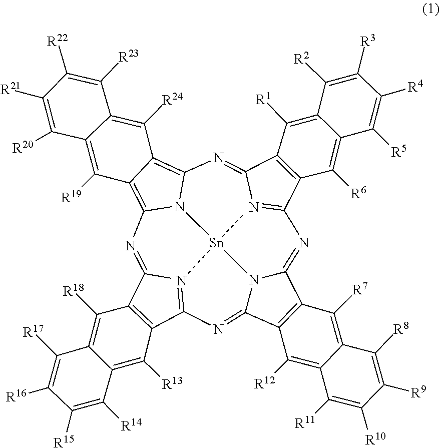

In general formula (1), R¹ to R²⁴ each independently represent a hydrogen atom or a substituent. The substituent is not limited to particular substituents. The substituent can be a deuterium atom, a halogen atom, an alkyl group (including a cycloalkyl group, a bicycloalkyl group, and a tricycloalkyl group), an alkenyl group (including a cycloalkenyl group and a bicycloalkenyl group), an alkynyl group, an aryl group, a heterocyclic group, a cyano group, a hydroxy group, a nitro group, a carboxy group, an alkoxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an ammonio group, an acylamino group, an aminocarbonylamino group, an alkoxycarbonylamino group, an aryloxycarbonylamino group, a sulfamoylamino group, an alkylsulfonylamino group, an arylsulfonylamino group, a mercapto group, an alkylthio group, an arylthio group, a heterocyclic thio group, a sulfamoyl group, a sulfo group, an alkylsulfinyl group, an arylsulfinyl group, an alkylsulfonyl group, an arylsulfonyl group, an acyl group, an aryloxycarbonyl group, an alkoxycarbonyl group, a carbamoyl group, an arylazo group, a heterocyclic azo group, an imide group, a phosphino group, a phosphinyl group, a phosphinyloxy group, a phosphinylamino group, a phosphono group, a silyl group, a hydrazino group, a ureide group, a boronic acid group (—B(OH)₂), a phosphato group (—OPO(OH)₂), a sulfato group (-—OSO₃H), or other publicly-known substituents.

As the tin naphthalocyanine represented by general formula (1) above, a commercially available product may be used. Alternatively, for example, as disclosed in Japanese Unexamined Patent Application Publication No. 2010-232410, the tin naphthalocyanine represented by general formula (1) above may be synthesized with a naphthalene derivative represented by general formula (2) below as a starting material. R²⁵ to R³⁰ in general formula (2) can be substituents that are similar to R¹ to R²⁴ in general formula (1).

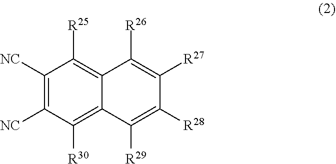

In the tin naphthalocyanine represented by general formula (1) above, eight or more of R¹ to R²⁴ may be hydrogen atoms or deuterium atoms, sixteen or more of R¹ to R²⁴ may be hydrogen atoms or deuterium atoms, or all of R¹ to R²⁴ may be hydrogen atoms or deuterium atoms from the point of view of ease of control of a molecular aggregation state. Furthermore, tin naphthalocyanine represented by general formula (3) below is advantageous in view of ease of synthesis.

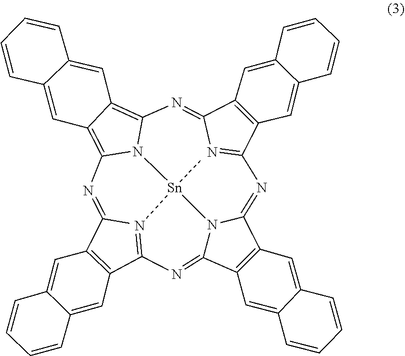

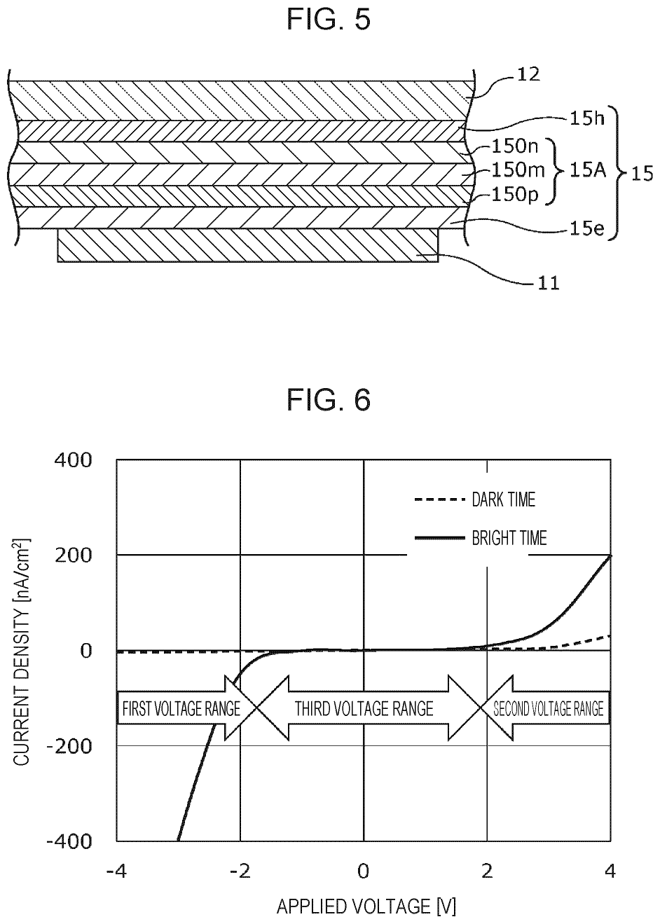

The tin naphthalocyanine represented by general formula (1) above has absorption in a wavelength range of approximately 200 nm to 1100 nm. The tin naphthalocyanine represented by general formula (3) above has an absorption peak at a wavelength of approximately 870 nm as shown in FIG. 4. FIG. 4 is a diagram showing an example of an absorbing spectrum in a photoelectric conversion layer containing the tin naphthalocyanine represented by general formula (3) above. It should be noted that the measurement of the absorption spectrum involves the use of a sample having a 30-nanometer-thick photoelectric conversion layer stacked over a quartz substrate.

As can be seen from FIG. 4, a photoelectric conversion layer made of a material containing tin naphthalocyanine has absorption in the visible light wavelength region and the near-infrared wavelength region. By selecting a material containing tin naphthalocyanine as a material of which the photoelectric conversion layer 15 is made, an optical sensor capable of detecting near infrared radiation can be achieved, for example. Further, instead of tin naphthalocyanine, a naphthalocyanine derivative whose central metal is not tin but silicon or another metal such as germanium may be used as a material of which the photoelectric conversion layer 15 is made. Further, axial ligands may coordinate to the central metal of the naphthalocyanine derivative.

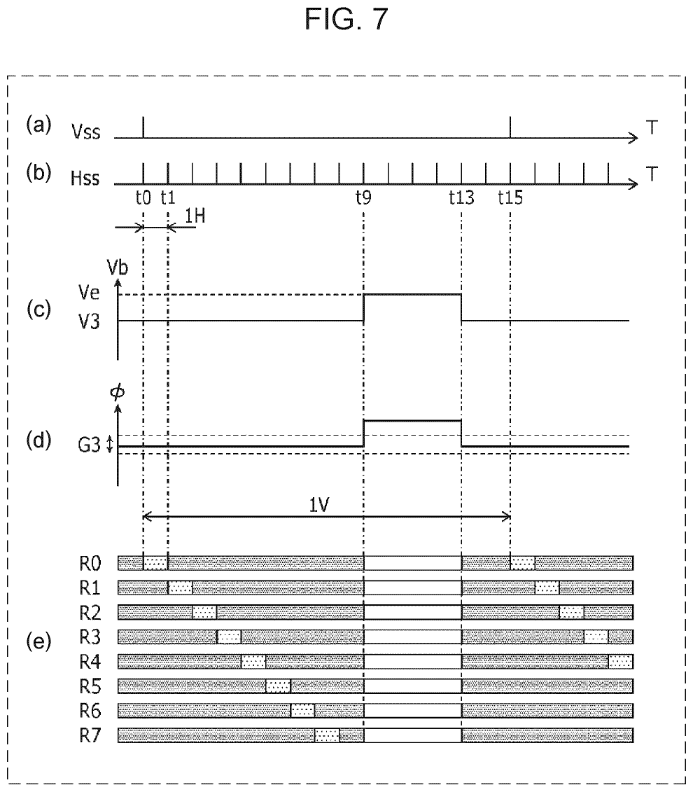

FIG. 5 is a cross-sectional view schematically showing an example of a configuration of the photoelectric conversion layer 15. In the configuration illustrated in FIG. 5, the photoelectric conversion layer 15 has, for example, a hole blocking layer 15h, a photoelectric conversion structure 15A, and an electron blocking layer 15c. The hole blocking layer 15h is placed between the photoelectric conversion structure 15A and the counter electrode 12, and the electron blocking layer 15e is placed between the photoelectric conversion structure 15A and the pixel electrode 11. It should be noted that the photoelectric conversion layer 15 does not need to have at least one of the hole blocking layer 15h and the electron blocking layer 15c.

The photoelectric conversion structure 15A shown in FIG. 5 contains, for example, at least one of a p-type semiconductor and an n-type semiconductor. In the configuration illustrated in FIG. 5, the photoelectric conversion structure 15A has a p-type semiconductor layer 150p, an n-type semiconductor layer 150n, and a mixed layer 150m sandwiched between the p-type semiconductor layer 150p and the n-type semiconductor layer 150n. The p-type semiconductor layer 150p is placed between the electron blocking layer 15c and the mixed layer 150m and has a photoelectric conversion and/or hole transport function. The n-type semiconductor layer 150n is placed between the hole blocking layer 15h and the mixed layer 150m and has a photoelectric conversion and/or electron transport function. As will be described later, the mixed layer 150m may contain at least one of a p-type semiconductor and an n-type semiconductor.

The p-type semiconductor layer 150p contains an organic p-type semiconductor, and the n-type semiconductor layer 150n contains an organic n-type semiconductor. Therefore, the photoelectric conversion structure 15A contains an organic photoelectric conversion material containing the tin naphthalocyanine represented by general formula (1) above, the organic p-type semiconductor, and the organic n-type semiconductor.

The organic p-type semiconductor is a donor organic semiconductor and, typified mainly by a hole transport organic compound, refers to an electron-donating organic compound. In more particular, the organic p-type semiconductor is a donor organic compound and refers to an organic compound that is lower in ionization potential when two organic materials are used in contact with each other. Accordingly, it is possible to use any electron-donating organic compound as the donor organic compound. Usable examples of the donor organic compound include metal complexes having, as ligands, a triarylamine compound, a benzidine compound, a pyrazoline compound, a styrylamine compound, a hydrazone compound, a triphenylmethane compound, a carbazole compound, a polysilane compound, a thiophene compound, a phthalocyanine compound, naphthalocyanine compound, a subphthalocyanine compound, a cyanine compound, a merocyanine compound, an oxonol compound, a polyamine compound, an indole compound, a pyrrole compound, a pyrazole compound, a polyarylene compound, a condensed aromatic carbocyclic compound (naphthalene derivative, anthracene derivative, phenanthrene derivative, tetracene derivative, pyrene derivative, perylene derivative, fluoranthene derivative), and a nitrogen-containing heterocyclic compound. The donor organic semiconductor is not limited to this, and an organic material that is lower in ionization potential than an organic material used as the after-mentioned acceptor organic compound can be used as the donor organic semiconductor. The aforementioned “tin naphthalocyanine” is an example of an organic p-type semiconductor material.

The organic n-type semiconductor is an acceptor organic semiconductor and, typified mainly by an electron transport organic compound, refers to an electron-accepting organic compound. In more particular, the organic n-type semiconductor is an acceptor organic compound and refers to an organic compound that is higher in ionization potential when two organic compounds are used in contact with each other. Accordingly, it is possible to use any electron-accepting organic compound as the acceptor organic compound. Usable examples of the acceptor organic compound include metal complexes having, as ligands, a fullerene, a fullerene derivative, a condensed aromatic carbocyclic compound (naphthalene derivative, anthracene derivative, phenanthrene derivative, tetracene derivative, pyrene derivative, perylene derivative, fluoranthene derivative), a 5- to 7-membered heterocyclic compound containing a nitrogen atom, an oxygen atom, or a sulfur atom (such as pyridine, pyrazine, pyrimidine, pyridazine, triazine, quinoline, quinoxaline, quinazoline, phthalazine, cinnoline, isoquinoline, pteridine, acridine, phenazine, phenanthroline, tetrazole, pyrazole, imidazole, thiazole, oxazole, indazole, benzimidazole, benzotriazole, benzoxazole, benzothiazole, carbazole, purine, triazolopyridazine, triazolopyrimidine, tetrazaindene, oxadiazole, imidazopyridine, pyrrolidine, pyrrolopyridine, thiadiazolopyridine, dibenzazepine, or tribenzazepine), a polyarylene compound, a fluorene compound, a cyclopentadiene compound, a silyl compound, and a nitrogen-containing heterocyclic compound. The acceptor organic semiconductor is not limited to this, and as mentioned above, an organic material that is higher in electron affinity than an organic material used as the donor organic compound can be used as the acceptor organic semiconductor.

The mixed layer 150m can be, for example, a bulk heterojunction structure layer including an organic p-type semiconductor and an organic n-type semiconductor. In a case where the mixed layer 150m is formed as a layer having a bulk heterojunction structure, the tin naphthalocyanine represented by general formula (1) above can be used as the organic p-type semiconductor material. As the organic n-type semiconductor material, for example, a fullerene and/or a fullerene derivative can be used.

From the point of view of improving photoelectric conversion efficiency, the material constituting the p-type semiconductor layer 150p may be the same as the p-type semiconductor material contained in the mixed layer 150m. Similarly, the material constituting the n-type semiconductor layer 150n may be the same as the n-type semiconductor material contained in the mixed layer 150m. A bulk heterojunction structure is described in detail in Japanese Patent No. 5553727, the entire contents of which are hereby incorporated by reference.

Using appropriate materials depending on the wavelength range to be detected makes it possible to achieve an imaging element 110 having sensitivity to the desired wavelength range. The photoelectric conversion layer 15 may contain an inorganic semiconductor material such as amorphous silicon or a compound semiconductor. The photoelectric conversion layer 15 may include a layer made of an organic material and a layer made of an inorganic material.

While the foregoing has described a photoelectric conversion layer 15 containing tin naphthalocyanine and having sensitivity to near infrared radiation, the material contained in the photoelectric conversion layer 15 is not limited to a photoelectric conversion material having sensitivity to near infrared radiation. For example, by containing subphthalocyanine as the p-type semiconductor and containing a fullerene and/or a fullerene derivative as the n-type semiconductor, the photoelectric conversion layer 15 can be a photoelectric conversion layer 15 having sensitivity to visible light.

### Photocurrent Characteristics of Photoelectric Converter

Next, the photocurrent characteristics of the photoelectric converter 13 are described.

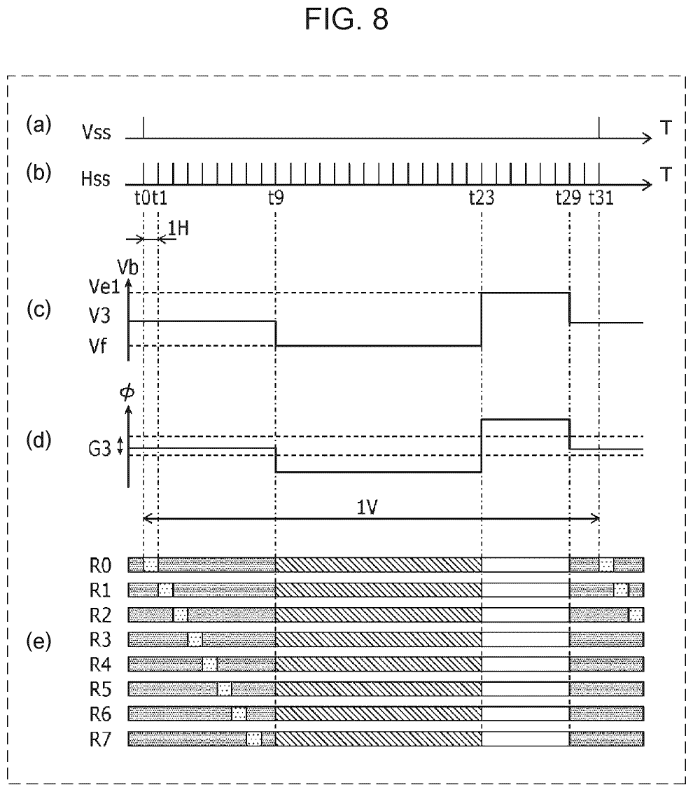

FIG. 6 is a diagram showing an exemplary photocurrent characteristic of the photoelectric converter 13. In the graph of FIG. 6, the solid line indicates an exemplary current-voltage characteristic (I-V characteristic) of the photoelectric converter 13 in a state of being illuminated with light (i.e. a bright time). In FIG. 6, the dotted line indicates an example of an I-V characteristic of the photoelectric converter 13 in a state of not being illuminated with light (i.e. a dark time).

FIG. 6 shows a change in the density of an electric current that, under constant illuminance, flows between principal surfaces of the photoelectric conversion layer 15 when a bias voltage that is applied between the pixel electrode 11 and the counter electrode 12 of the photoelectric converter 13 is changed. Forward and backward bias voltages are herein defined as follows. In a case where the photoelectric conversion layer 15 has a junction structure of a layered p-type semiconductor and a layered n-type semiconductor, a bias voltage that makes a layer of the p-type semiconductor layer higher in potential than a layer of the n-type semiconductor layer is defined as a forward bias voltage. On the other hand, a bias voltage that makes the layer of the p-type semiconductor layer lower in potential than the layer of the n-type semiconductor layer is defined as a backward bias voltage. In a case where the photoelectric conversion layer 15 has a bulk heterojunction structure, as schematically shown in FIG. 1 of the aforementioned Japanese Patent No. 5553727, more of the p-type semiconductor than the n-type semiconductor appears in one of two principal surfaces of the bulk heterojunction structure that faces an electrode, and more of the n-type semiconductor than the p-type semiconductor appears in the other principal surface. Accordingly, a bias voltage that makes the potential on the principal surface in which more of the p-type semiconductor than the n-type semiconductor appears higher than the potential on the principal surface in which more of the n-type semiconductor than the p-type semiconductor appears is defined as a forward bias voltage. In the present embodiment, for example, a voltage that makes the potential of the counter electrode 12 higher than the potential of the pixel electrode 11 is a backward bias voltage, and a voltage that makes the potential of the counter electrode 12 lower than the potential of the pixel electrode 11 is a forward bias voltage.

As shown in FIG. 6, the photocurrent characteristic of the photoelectric converter 13 is schematically characterized by three voltage ranges, namely first to third voltage ranges. The first voltage range is a range of backward bias voltages, and is a voltage range in which the absolute value of an output current density increases with an increase in backward bias voltage. The first voltage range may also be said to be a voltage range in which a photoelectric current increases with an increase in a bias voltage that is applied between the pixel electrode 11 and the counter electrode 12. The second voltage range is a range of forward bias voltages, and is a voltage range in which the output current density increases with an increase in forward bias voltage. That is, the second voltage range is a voltage range in which a photocurrent that is opposite in direction to the first voltage range increases with an increase in a bias voltage that is applied between the pixel electrode 11 and the counter electrode 12. The third voltage range is a voltage range between the first voltage range and the second voltage range. In the example shown in FIG. 6, the rates of change in output current density in response to increases in bias voltage in the first voltage range, the second voltage range, and the third voltage range are different from one another. Further, the third voltage range is defined as a voltage range in which the rate of change in output current density voltage in response to an increase in bias voltage is lower than the rates of change in output current density in response to increases in bias voltage in the first voltage range and the second voltage range. Alternatively, the third voltage range may be determined on the basis of the position of a rising edge (falling edge) in the graph of the I-V characteristic. The third voltage range is for example larger than −2 V and smaller than +2 V. In the third voltage range, a change in bias voltage causes almost no change in current density between the principal surfaces of the photoelectric conversion layer 15. As illustrated in FIG. 6, in the third voltage range, the absolute value of the current density is for example less than or equal to 100 nA/cm².

Further, in the case of comparisons made under the same illuminance conditions, the difference between a dark-time current and a bright-time current in the third voltage range is smaller than the difference between a dark-time current and a bright-time current in the first voltage range and the difference between a dark-time current and a bright-time current in the second voltage range. The term “dark-time current” here means an electric current that flows through the photoelectric conversion layer 15 in a state of not being illuminated with light, and the term “bright-time current” here means an electric current that flows through the photoelectric conversion layer 15 in a state of being illuminated with light.

The I-V characteristic of the photoelectric converter 13 shown in FIG. 6 is merely an example, and an intended I-V characteristic can be attained by adjusting the configuration and material of the photoelectric conversion layer 15 described above.

### Example of Operation of Imaging Device

Next, how the imaging device 100 operates is described.

### (1) Normal Imaging Operation

First, as an operation of the imaging device 100, an operation in which a normal image is taken is described. Driving of the imaging device 100 in a mode of taking a normal image as explained below is herein referred to as “normal imaging driving”.

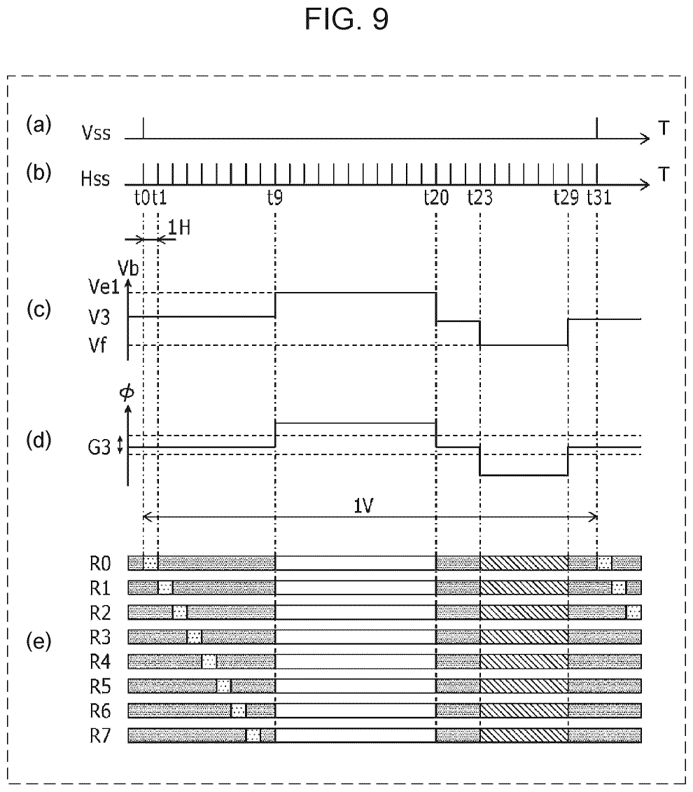

FIG. 7 is a diagram for explaining an example of an operation of normal imaging driving in the imaging device 100 according to the present embodiment. FIG. 7 shows the timing of falling edges or rising edges of synchronization signals, temporal changes in the magnitude of a bias voltage that is applied to the photoelectric converter 13, and the timing of resets and exposures in each row of the pixel array PA (see FIG. 2) together.

More specifically, graph (a), at the top of FIG. 7, shows the timing of falling edges or rising edges of a vertical synchronization signal Vss. Graph (b) of FIG. 7 shows the timing of falling edges or rising edges of a horizontal synchronization signal Hss. Graph (c) of FIG. 7 shows an example of a temporal change in a voltage Vb that is applied from the voltage supply circuit 32 to the counter electrode 12 via the sensitivity control line 42. Graph (d) of FIG. 7 shows a temporal change in a potential φ (i.e. a bias voltage) of the counter electrode 12 with reference to the potential of the pixel electrode 11. The double-headed arrow G3 in graph (d) of the potential o indicates the aforementioned third voltage range. Further, in this example, the first voltage range is above the double-headed arrow G3, and the second voltage range is below the double-headed arrow G3. Chart (c) of FIG. 7 schematically shows the timing of resets and exposures in each row of the pixel array PA.

The following describes an example of the operation of normal imaging driving in the imaging device 100 with reference to FIGS. 2, 3, and 7. For simplicity, the following describes an example of operation in which the pixel array PA includes a total of eight rows of pixels 10, namely the R0th to R7th rows. It should be noted that the order of pixel rows shown in chart (e) of FIG. 7 does not need to coincide with the actual order of pixel rows, and the actual arrangement of pixels is not limited in particular.

In the acquisition of an image, first, the resetting of the charge storage region of each pixel 10 in the pixel array PA and the reading out of a post-reset pixel signal are executed. For example, as shown in FIG. 7, the resetting of a plurality of pixels 10 belonging to the R0th row is started in accordance with the vertical synchronization signal Vss (time t0). It should be noted that the low-density halftone dotted rectangles in chart (c) schematically represent signal readout periods. These readout periods can include, as part thereof, reset periods in which to reset the potentials of the charge storage regions of the pixels 10.

In the resetting of a pixel 10 belonging to the R0th row, the address transistor 26, whose gate is connected to the address control line 46 of the R0th row, is turned on by controlling the potential of the address control line 46, and the reset transistor 28, whose gate is connected to the reset control line 48 of the R0th row, is turned on by controlling the potential of the reset control line 48. As a result of this, the charge storage node 41 and the reset voltage line 44 become connected to each other, and the reset voltage Vr is supplied to the charge storage region. That is, the potentials of the charge storage node 41, the gate electrode 24g of the signal detection transistor 24, and the pixel electrode 11 of the photoelectric converter 13 are reset to the reset voltage Vr. After that, a pixel signal corresponding to the potential of the charge storage region after the resetting is read out from the pixel 10 of the R0th row via the vertical signal line 47. The pixel signal thus obtained is a pixel signal corresponding to the magnitude of the reset voltage Vr. After the reading out of the pixel signal, the reset transistor 28 and the address transistor 26 are turned off. In a case where a pixel signal corresponding to the quantity of electric charge stored in the charge storage region of the pixel 10 in the preceding frame is read out, the reading out of a pixel signal may also be performed prior to the resetting.

In this example, as schematically shown in FIG. 7, the resetting of pixels 10 belonging separately to each of the R0th to R7th rows are executed in sequence on a row-by-row basis in synchronization with the horizontal synchronization signal Hss. In the following, a pulse interval of the horizontal synchronization signal Hss, i.e., a period from selection of one row to selection of the next row, is sometimes called a “1H period”. In this example, the 1H period is equivalent to the period from time t0 to time t1.

As shown in FIG. 7, during the period from the start of image acquisition to the end of the resetting of all rows of the pixel array PA and the reading out of pixel signals (from time t0 to time t9), such a voltage V3 is applied from the voltage supply circuit 32 to the counter electrode 12 that the voltage that is applied between the pixel electrode 11 and the counter electrode 12 falls within the aforementioned third voltage range. That is, during the period from the start of image acquisition to the start (time t9) of the exposure period, a bias voltage in the third voltage range is applied between the pixel electrode 11 and the counter electrode 12.

In the presence of the application of a bias voltage in the third voltage range between the pixel electrode 11 and the counter electrode 12, the migration of electric charge from the photoelectric conversion layer 15 to the charge storage region hardly occurs. A reason for this is that in the presence of the application of a bias voltage in the third voltage range between the pixel electrode 11 and the counter electrode 12, most positive and negative charges generated by illumination with light rapidly recombine to disappear before being collected by the pixel electrode 11. Accordingly, in the presence of the application of a bias voltage in the third voltage range between the pixel electrode 11 and the counter electrode 12, the storage of electric charge into the charge storage region hardly occurs even when light falls on the photoelectric conversion layer 15. This reduces the occurrence of unintended sensitivity in a period other than the exposure period. Such unintended sensitivity is also called “parasitic sensitivity”.

With attention focused on a certain row (e.g. the R0th row) in chart (c) of FIG. 7, the periods indicated by the low-density halftone dotted rectangles and the high-density halftone dotted rectangles represent the non-exposure period. In the example shown in FIG. 7, a bias voltage in the third voltage range is applied between the pixel electrode 11 and the counter electrode 12 during the non-exposure period. It should be noted that the voltage V3, which causes a bias voltage in the third voltage range to be applied between the pixel electrode 11 and the counter electrode 12, is not limited to 0 V. The voltage V3 is set according to the reset voltage Vr so that the bias voltage falls within the third voltage range. The bias voltage that is applied between the pixel electrode 11 and the counter electrode 12 by the voltage V3 being supplied to the counter electrode 12 is an example of a third voltage, and the bias voltage is hereinafter sometimes referred to as a “third voltage”.

Next, after the end of the resetting of all rows of the pixel array PA and the reading out of pixel signals, the exposure period is started in accordance with the horizontal synchronization signal Hss (time t9). In chart (e) of FIG. 7, the white rectangles schematically represent the exposure period separately in each row. The exposure period is started by the voltage supply circuit 32 switching to applying the voltage Ve, which is different from the voltage V3, to the counter electrode 12. The voltage Ve is, for example, such a voltage (e.g. approximately 10 V) that the bias voltage that is applied between the pixel electrode 11 and the counter electrode 12 falls within the aforementioned first voltage range. By the voltage Ve being applied to the counter electrode 12, electric charge (in this example, a hole) in the photoelectric conversion layer 15 is collected by the pixel electrode 11 and stored in the charge storage region including the charge storage node 41. The voltage Ve is set, for example, according to the reset voltage Vr so that the bias voltage falls within the first voltage range. The bias voltage that is applied between the pixel electrode 11 and the counter electrode 12 by the voltage Ve being supplied to the counter electrode 12 is an example of a fourth voltage, and the bias voltage is hereinafter sometimes referred to as a “fourth voltage”. In the exposure period during which the fourth voltage is applied between the pixel electrode 11 and the counter electrode 12, an increase in the amount of light that falls on the photoelectric converter 13 causes an increase in luminance value in image data that is outputted from the imaging device 100.

Next, the voltage supply circuit 32 switches again to applying the voltage V3 to the counter electrode 12, whereby the exposure period ends (time t13). Thus, in the imaging device 100, switching between applying the voltage V3 to the counter electrode 12 and applying the voltage Ve to the counter electrode 12 enables switching between the exposure period and the non-exposure period. As can be seen from FIG. 7, the start (time t9) and end (time t13) of the exposure period in this example are common to all pixels 10 included in the pixel array PA. That is, the operation described here is an example in which the global shutter method is applied to the imaging element 110. The imaging device 100 is driven by the global shutter method, in which the exposure period is defined by changing a voltage that the voltage supply circuit 32 applies between the pixel electrode 11 and the counter electrode 12.

Next, the reading out of pixel signals from pixels 10 belonging separately to each row of the pixel array PA is performed in accordance with the horizontal synchronization signal Hss. In this example, the reading out of pixel signals from pixels 10 belonging separately to each of the R0th to R7th rows are executed in sequence on a row-by-row basis from time t15. In the following, the period from selection of a pixel 10 belonging to one row to reselection of a pixel 10 belonging to the row is sometimes called a “1V period”. In this example, the 1V period is equivalent to the period from time t0 to time t15. The 1V period is, for example, a one-frame period. As in the example shown in FIG. 7, the 1V period during which the normal imaging driving is performed is an example of a second frame period.

In the reading out, which starts at time t15, of a pixel signal from a pixel 10 belonging to the R0th row after the end of the exposure period, first the address transistor 26 of the R0th row is turned on. This causes a pixel signal corresponding to the quantity of electric charge stored in the charge storage region during the exposure period, i.e. the potential of the charge storage region after the exposure period, to be outputted to the vertical signal line 47. The reading out of the pixel signal may be followed by the turning on of the reset transistor 28 to perform the resetting of the pixel 10. Further, if necessary, this resetting may be followed by the reading out of the pixel signal. The reading out of the pixel signal is followed by the turning off of the address transistor 26 and, in a case where the resetting of the pixel 10 has been performed, also followed by the turning off of the reset transistor 28.

After the reading out of pixel signals from pixels 10 belonging separately to each row of the pixel array PA, signals from which stationary noise has been eliminated are obtained by taking the differences between the pixel signals and post-reset pixel signals read out during the period between time t0 and time t9. This elimination of stationary noise is performed, for example, by the column signal processing circuits 37. Further, the elimination of stationary noise may be performed before AD conversion of the pixel signals or may be performed after AD conversion of the pixel signals. In a case where resets are performed after the reading out of pixel signals after the exposure periods, signals from which stationary noise has been eliminated may be obtained by taking the differences between readouts of pixel signals after the resets and readouts of pixel signals before the resets.

In the non-exposure period, during which the voltage V3 is applied to the counter electrode 12, a bias voltage in the third voltage range is applied to the photoelectric converter 13. Therefore, the further storage of electric charge into the charge storage region hardly occurs even when light falls on the photoelectric conversion layer 15. This inhibits the generation of noise attributed to unintended contamination with electric charge.

In this example, since switching to applying the voltage V3 to the counter electrode 12 is done again after the end of the exposure period, a bias voltage in the third voltage range is applied to the photoelectric converter 13 after the storage of electric charge into the charge storage region. In the presence of the application of a bias voltage in the third voltage range, it is possible to inhibit electric charge already stored in the charge storage region from migrating to the counter electrode 12 via the photoelectric conversion layer 15. In other words, the application of a bias voltage in the third voltage range to the photoelectric converter 13 makes it possible to retain, in the charge storage region, electric charge stored during the exposure period. This makes it possible to reduce the occurrence of negative parasitic sensitivity due to a loss of electric charge stored in the charge storage region.

Thus, in the present embodiment, the start and end of the exposure period are controlled by the voltage Vb, which is applied to the counter electrode 12. That is, the present embodiment makes it possible to achieve a global shutter function without providing a transfer transistor or other components in each pixel 10. The present embodiment, in which an operation of an electronic shutter is executed by controlling the voltage Vb without transferring electric charge via a transfer transistor, makes faster operation possible. Further, not needing to separately provide a transfer transistor or other components in each pixel 10 is advantageous to finer pixels.

Although the foregoing has described, as the normal imaging driving, a case where the imaging device 100 is driven by the global shutter method, the imaging device 100 may be driven by the rolling shutter method in the normal imaging driving. In this case, for example, the voltage Ve is constantly applied to the counter electrode 12. Further, in each pixel 10, a reset operation ends when the exposure period starts, and the subsequent readout operation starts when the exposure period ends. For example, in a case where the reset operation and the readout operation are performed at timings shown in FIG. 7, the exposure period of a pixel 10 belonging to the R0th row lasts from time t1 to time t15.

### (2) Moving Object Detection Operation

Next, as an operation of the imaging device 100, an operation in which a moving object is detected is described. Driving of the imaging device 100 in a mode of detecting a moving object as explained below is herein referred to as “moving object detection driving”. The following description of an operation of moving object detection driving is given with a focus on points of difference from the foregoing operation of normal imaging driving, and a description of common features are omitted or simplified.

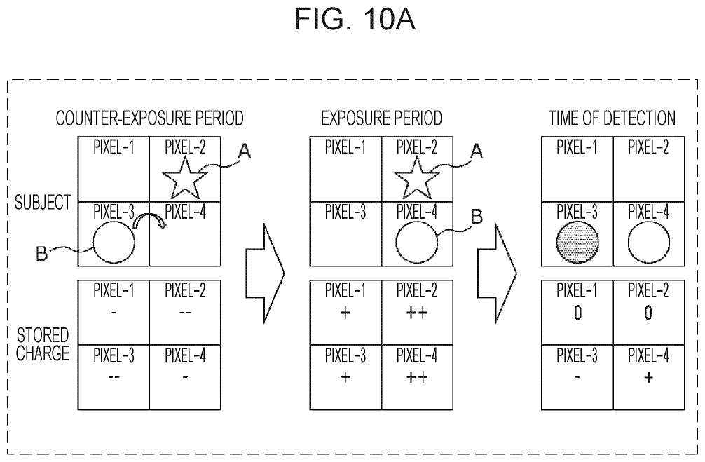

FIG. 8 is a diagram for explaining an example of the operation of moving object detection driving in the imaging device 100 according to the present embodiment. Graphs (a) to (d) and chart (c) of FIG. 8 show the same items as those of graphs (a) to (d) and chart (c) of FIG. 7. Further, in addition to the periods described in chart (e) of FIG. 7, chart (e) of FIG. 8 shows the after-mentioned counter-exposure period with diagonally shaded rectangles.

The following describes an example of the operation of moving object detection driving in the imaging device 100 with reference to FIGS. 2, 3, and 8. For simplicity, as in the case of FIG. 7, the following describes an example of operation in which the pixel array PA includes a total of eight rows of pixels 10, namely the R0th to R7th rows. It should be noted that the order of pixel rows shown in chart (e) of FIG. 8 does not need to coincide with the actual order of pixel rows, and the actual arrangement of pixels is not limited in particular.

In the detection of a moving object, first, the resetting of the charge storage region of each pixel 10 in the pixel array PA and the reading out of a post-reset pixel signal are executed. As for the resetting of the charge storage region of each pixel 10 and the reading out of a post-reset pixel signal, the same operation is performed as that which lasts from time t0 to time t9 in FIG. 7.

Next, after the end of the resetting of all rows of the pixel array PA and the reading out of pixel signals, the counter-exposure period is started in accordance with the horizontal synchronization signal Hss (time t9). The counter-exposure period is started by the voltage supply circuit 32 switching to applying a voltage Vf, which is different from the voltage V3, to the counter electrode 12. The voltage Vf is, for example, such a voltage that the bias voltage that is applied between the pixel electrode 11 and the counter electrode 12 falls within the aforementioned second voltage range. By the voltage Vf being applied to the counter electrode 12, electric charge (in this example, an electron) in the photoelectric conversion layer 15 is collected by the pixel electrode 11 and stored in the charge storage region including the charge storage node 41. The voltage Vf is set according to the reset voltage Vr so that the bias voltage falls within the second voltage range. The difference between the reset voltage Vr and the voltage Vf is, for example, greater than or equal to 2 V and less than or equal to 10 V. In the counter-exposure period, the bias voltage that is applied between the pixel electrode 11 and the counter electrode 12 by the voltage Vf being supplied to the counter electrode 12 is an example of a first voltage, and the bias voltage is hereinafter sometimes referred to as a “first voltage”. Further, the counter-exposure period in the moving object detection driving is an example of a first period.

Next, the voltage supply circuit 32 switches from applying the voltage Vf to the counter electrode 12 to applying a voltage Ve1 to the counter electrode 12, whereby the counter-exposure period ends and the exposure period starts (time t23). In the present example of operation, the counter-exposure period is started by the voltage supply circuit 32 switching to applying the voltage Ve1, which is different from the voltage V3 and the voltage Vf, to the counter electrode 12. The voltage Ve1 is, for example, such a voltage that the bias voltage that is applied between the pixel electrode 11 and the counter electrode 12 falls within the aforementioned first voltage range. The voltage Ve1 may be the same as or different from the voltage Ve. By the voltage Ve1 being applied to the counter electrode 12, electric charge (in this example, a hole) in the photoelectric conversion layer 15 is collected by the pixel electrode 11 and stored in the charge storage region including the charge storage node 41. Since the electric charge that is stored in the charge storage region during the counter-exposure period and the electric charge that is stored in the charge storage region during the exposure period are opposite in polarity to each other, the electric charge that is stored in the charge storage region during the counter-exposure period and the electric charge that is stored in the charge storage region during the exposure period cancel each other out. The voltage Ve1 is set according to the reset voltage Vr so that the bias voltage falls within the first voltage range. The difference between the reset voltage Vr and the voltage Ve1 is, for example, greater than or equal to 2 V and less than or equal to 10 V. In the exposure period, the bias voltage that is applied between the pixel electrode 11 and the counter electrode 12 by the voltage Ve1 being supplied to the counter electrode 12 is an example of a second voltage that is opposite in polarity to the first voltage, which is a bias voltage in the counter-exposure period, and the bias voltage is hereinafter sometimes referred to as a “second voltage”. Further, the second voltage is identical in polarity to the fourth voltage. Further, the second voltage is a voltage of such a polarity that the magnitude of a signal that is detected by the signal detection circuit 14 by light falling on the photoelectric converter 13 and inputted to the signal processing circuit 120 increases. Further, the exposure period in the moving object detection driving is an example of a second period.

Next, the voltage supply circuit 32 switches again to applying the voltage V3 to the counter electrode 12, whereby the exposure period ends (time t29). The third voltage, which is applied between the pixel electrode 11 and the counter electrode 12 by the voltage supply circuit 32 applying the voltage V3 to the counter electrode 12, is a voltage between the first voltage and the second voltage. Further, since the third voltage falls within the third voltage range, the third voltage is smaller in absolute value than the first voltage and the second voltage.

Thus, in the imaging element 110, switching among applying the voltage V3 to the counter electrode 12, applying the voltage Vf to the counter electrode 12, and applying the voltage Ve1 to the counter electrode 12 enables switching among the non-exposure period, the counter-exposure period, and the exposure period. As can be seen from FIG. 8, the start (time t9) and end (time t23) of the counter-exposure period and the start (time t23) and end (time t29) of the exposure period in this example are common to all pixels 10 included in the pixel array PA. That is, in the imaging device 100, the exposure period and the counter-exposure period are defined by changes in voltage that the voltage supply circuit 32 applies between the pixel electrode 11 and the counter electrode 12.

Next, the reading out of pixel signals from pixels 10 belonging separately to each row of the pixel array PA is performed in accordance with the horizontal synchronization signal Hss. In this example, during a non-exposure period starting from time t31, the same readout operation is performed as that which starts from time t15 in FIG. 7. This causes pixel signals corresponding to the quantities of electric charge stored in the charge storage regions during the counter-exposure period and the exposure period, i.e. the potentials of the charge storage regions after the counter-exposure period and the exposure period, to be outputted to the vertical signal lines 47. The non-exposure period starting from time t31 after the counter-exposure period and the exposure period is an example of a third period.

The pixel signals outputted to the vertical signal lines 47 are outputted to the signal processing circuit 120 via the column signal processing circuits 37, where stationary noise elimination, AD conversion, or other processes are performed, or other circuits. The signal processing circuit 120 generates, based on the pixel signals subjected to stationary noise elimination, AD conversion, or other processes in the column signal processing circuits 37, a detection signal that is an example of a second signal pertaining to a moving object moving in the 1V period. In this example, the 1V period is equivalent to the period from time t0 to time t31. As in the example shown in FIG. 8, the 1V period during which the moving object detection driving is performed is an example of a first frame period. It should be noted that stationary noise elimination is not mandatory. Therefore, the reading out of post-reset pixel signals does not need to be performed, either.

In the moving object detection driving, the magnitudes of the first voltage and the second voltage and the lengths of the counter-exposure period and the exposure period are not limited to particular magnitudes or lengths and can be set depending on purposes or other reasons.

For example, in a case where the amount of light that falls on the photoelectric converter 13 is constant, the accuracy with which the moving object is detected can be increased by setting the magnitudes of the first voltage and the second voltage and the lengths of the counter-exposure period and the exposure period such that the quantity of electric charge that is stored during the counter-exposure period and the quantity of electric charge that is stored during the exposure period are substantially the same.

As one example, a specific example of the magnitudes of the first voltage and the second voltage and the lengths of the counter-exposure period and the exposure period in an imaging device 100 including a photoelectric converter 13 having a photocurrent characteristic shown in FIG. 6 is described. For example, let it be assumed that the reset voltage Vr (i.e. a reset level) and the voltage V3, which is applied to the counter electrode 12, are 1 V during reading out and resetting, that the voltage Vf, which is applied to the counter electrode 12 during the counter-exposure period, is −3 V, that the counter-exposure period is 10 ms, that the voltage Ve1, which is applied to the counter electrode 12 during the exposure period, is 4 V, and that the exposure period is 5 ms.

With this, in a pixel 10 on which only light from a motionless object falls, the quantity of holes that have migrated to the charge storage region during the exposure period and the quantity of electrons that have migrated to the charge storage region during the counter-exposure period can be made substantially the same. For simplicity of explanation, the following assumes that the quantity of holes that have migrated to the charge storage region during the exposure period and the quantity of electrons that have migrated to the charge storage region during the counter-exposure period are completely the same. That is, the potential of the charge storage region of the pixel 10 on which the light from the motionless object is brought to the reset level, and a pixel signal corresponding to the reset level is detected.

Meanwhile, as for pixels 10 on which light from a bright moving object falls, particularly in a pixel 10 on which the light from the moving object has fallen only during the counter-exposure period, the quantity of electrons that have migrated to the charge storage region during the counter-exposure period is larger than the quantity of holes that have migrated to the charge storage region during the exposure period. That is, the potential of the charge storage region of the pixel 10 on which the light from the moving object falls during the counter-exposure period is lower than the reset level, and a pixel signal that is smaller than the pixel signal corresponding to the reset level is detected. Further, in a pixel 10 on which the light from the moving object falls only during the exposure period, the quantity of holes that have migrated to the charge storage region during the exposure period is larger than the quantity of electrons that have migrated to the charge storage region during the counter-exposure period. That is, the potential of the charge storage region of the pixel 10 on which the light from the moving object falls during the exposure period is higher than the reset level, and a pixel signal that is larger than the pixel signal corresponding to the reset level is detected. Accordingly, the signal processing circuit 120 can detect the moving object by comparing the magnitude of a pixel signal detected in each pixel 10 with the magnitude of the pixel signal corresponding to the reset level.

The foregoing example is merely an example, and for example, a voltage that is applied to the counter electrode during the exposure period and a voltage that is applied to the counter electrode during the counter-exposure period may be opposite in polarity to each other so that the electric charge that migrates to the charge storage region may be reversed between holes and electrons. Further, the potential of the charge storage region of the pixel 10 on which only the light from the motionless object falls does not need to be brought to the reset level. For example, by comparing the magnitude of a pixel signal detected in each pixel 10 with a predetermined reference value such as the magnitude of a pixel signal corresponding to the potential of the charge storage region of the pixel 10 on which only the light from the motionless object falls, the signal processing circuit 120 can detect the moving object. Further, the reset voltage Vr is not limited to 1 V but can be set as long as it is a voltage between the voltage Vf and the voltage Ve1. For example, the reset voltage Vr may be 0 V.

Further, in the example shown in FIG. 8, the absolute value of the second voltage, which is a bias voltage during the exposure period, is greater than the absolute value of the first voltage, which is a bias voltage during the counter-exposure period. During the counter-exposure period, electric charge of such a polarity is generated that the luminance value of an image decreases; therefore, in a case where the quantity of electric charge that is generated during the counter-exposure period is too large, a lower limit is set to a signal value to make it hard for there to be a difference in magnitude of signals between pixels 10, making it hard for the moving object to be detected. Therefore, with the second voltage being large, there is an increase in sensitivity during the exposure period. This makes it easier for there to be a difference in magnitude of signals between pixels 10, making it possible to increase the accuracy of detecting the moving object. Further, the first voltage is a voltage that is opposite in polarity to a voltage that is applied during normal imaging, and with the first voltage being small, there can be a reduction in an electric current that flows through the photoelectric converter 13 in a direction opposite to the direction in which an electric current flows during normal imaging. This makes it possible to increase the stability of the photoelectric converter 13. Further, with the first voltage being small, a dark current that comparatively easily flows through a forward bias region in the second voltage range can be suppressed. The absolute value of the second voltage may be equal to the absolute value of the first voltage or may be less than the absolute value of the first voltage.

Further, in the example shown in FIG. 8, the exposure period is shorter than the counter-exposure period. Thus, since the exposure period, during which the sensitivity of the photoelectric converter 13 is high because the absolute value of the second voltage is great, is short, it becomes easier to recognize the shape of an object even when the object is moving at high speed. The length of the exposure period may be equal to the length of the counter-exposure period, or may be longer than that of the counter-exposure period.

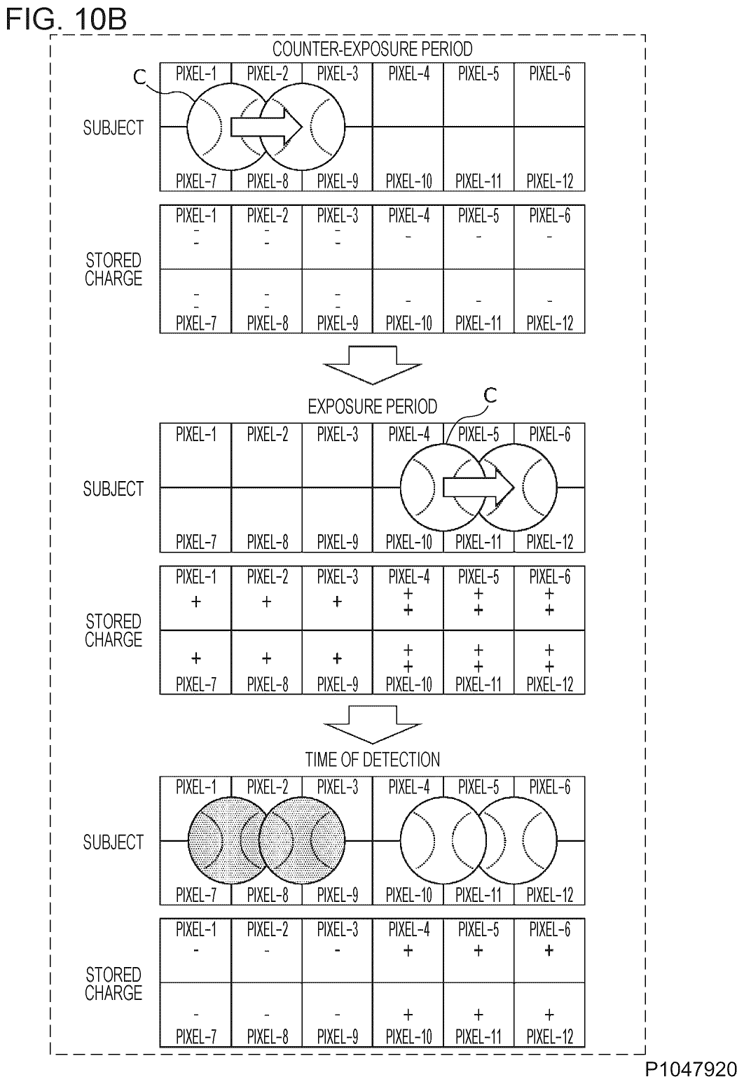

Further, although, in the example shown in FIG. 8, the exposure period starts immediately after the counter-exposure period, this is not intended to impose any limitation. As long as the exposure period and the counter-exposure period are present within a one-frame period, it is possible to detect a moving object. FIG. 9 is a diagram for explaining another example of the operation of moving object detection driving in the imaging device 100 according to the present embodiment. Graphs (a) to (d) and chart (c) of FIG. 9 show the same items as those of graphs (a) to (d) and charts (c) of FIGS. 7 and 8.

In the example shown in FIG. 9, the exposure period starts at time t9. Then, at time t20, the voltage supply circuit 32 switches from applying the voltage Ve1 to the counter electrode 12 to applying the voltage V3 to the counter electrode 12, whereby the exposure period ends. After that, at time t23, the voltage supply circuit 32 switches from applying the voltage V3 to the counter electrode 12 to applying the voltage Vf to the counter electrode 12, whereby the counter-exposure period starts. Then, at time t29, the voltage supply circuit 32 switches from applying the voltage Vf to the counter electrode 12 to applying the voltage V3 to the counter electrode 12, whereby the counter-exposure period ends. Then, from time t31 on, the reading out of pixel signals from pixels 10 belonging separately to each row of the pixel array PA is performed.

Thus, in the example shown in FIG. 9, the counter-exposure period starts after the exposure period. Further, the voltage supply circuit 32 does not change from applying the voltage Ve1 during the exposure period directly to applying the voltage Vf during the counter-exposure period but switches from supplying the voltage V3 to supplying the voltage Vf after switching from supplying the voltage Ve1 to supplying the voltage V3 once. That is, the non-exposure period is present between the exposure period and the counter-exposure period. Further, in the example shown in FIG. 9, the absolute value of the second voltage is less than the absolute value of the first voltage. Further, the exposure period is longer than the counter-exposure period.

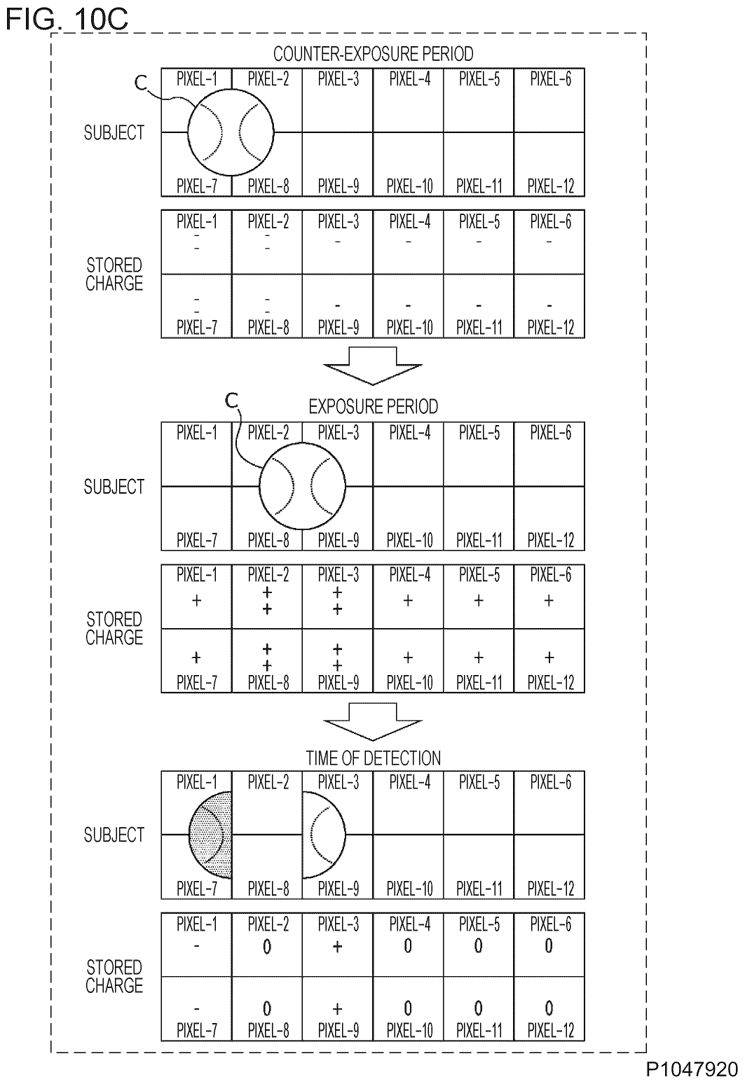

Next, specific examples in which the imaging device 100 detects a moving object through the foregoing operation is described with reference to FIGS. 10A to 10C. FIGS. 10A to 10C are diagrams for explaining specific examples of the operation of moving object detection driving in the imaging device 100 according to the present embodiment and detection results.

FIGS. 10A to 10C show examples of cases where the operation in the counter-exposure period is performed first and then the operation in the exposure period is performed, as in the case of the example shown in FIG. 8. Further, in the examples shown in FIGS. 10A to 10C, electrons are stored in the charge storage region by light falling on the photoelectric converter 13 during the counter-exposure period, and holes are stored in the charge storage region by light falling on the photoelectric converter 13 during the exposure period.

In section “COUNTER-EXPOSURE PERIOD” of each of FIGS. 10A to 10C, the position of an image of a subject during the counter-exposure period is schematically shown on the upper side, and the quantity of electrons that are stored in the charge storage regions during the counter-exposure period is schematically shown on the lower side. In section “EXPOSURE PERIOD” of each of FIGS. 10A to 10C, the position of an image of a subject during the exposure period is schematically shown on the upper side, and the quantity of holes that are stored in the charge storage regions during the exposure period is schematically shown on the lower side. In section “TIME OF DETECTION” of each of FIGS. 10A to 10C, the position of an image of a subject corresponding to a signal detected during the readout period is schematically shown on the upper side, and the quantity of electric charge that is stored in the charge storage regions during the readout period is schematically shown on the lower side. In section “STORED CHARGE”, a larger number of signs “−” indicate a larger quantity of stored electrons, a larger number of signs “+” indicate a larger quantity of stored holes, and a charge storage region with the number “0” indicates that substantially no electric charge is stored in the charge storage region with electrons and holes canceling each other out.

FIG. 10A shows an example of a case where an image of a bright object A is present in the “PIXEL-2” and an image of a bright object B is present in the “PIXEL-3” during the counter-exposure period and the image of the bright object A is present in the “PIXEL-2” and the image of the bright object B is present in the “PIXEL-4” during the exposure period, i.e. a case where the image of the bright object B has moved from the “PIXEL-3” to the “PIXEL-4” in the period of time between the counter-exposure period and the exposure period. A pixel in which an image of an object is present means a pixel on which light from the object falls.

In this case, the image of the object A that is present in the “PIXEL-2” is not moving. Therefore, in the “PIXEL-2”, a relatively large quantity of electrons is stored during the counter-exposure period, and a relatively large quantity of holes are stored during the exposure period. As a result of that, the quantity of electric charge that is stored in the “PIXEL-2” during the readout period is 0 in total. That is, in the “PIXEL-2”, a reference pixel signal representing a case where no electric charge is stored in the charge storage region, e.g. a pixel signal corresponding to the reset level, is detected by the signal detection circuit 14. As a result of that, the pixel signal that is detected by the signal detection circuit 14 in the “PIXEL-2” does not contain information indicating the presence of the object A.

Meanwhile, in the “PIXEL-3”, a relatively large quantity of electrons is stored during the counter-exposure period, as the image of the bright object B is present, and the quantity of stored holes is not relatively large during the exposure period, as the image of the bright object B is not present. Therefore, as a pixel signal that is detected by the signal detection circuit 14 in the “PIXEL-3”, a pixel signal that is more negative than the reference pixel signal, i.e. a blacker pixel signal indicating a lower and blacker luminance than does the reference pixel signal, is outputted. Further, in the “PIXEL-4”, the quantity of stored electrons is not relatively large during the counter-exposure period, as the image of the bright object B is not present, and a relatively large quantity of holes is stored during the exposure period, as the image of the bright object B is present. Therefore, as a pixel signal that is detected by the signal detection circuit 14 in the “PIXEL-4”, a pixel signal that is more positive than the reference pixel signal, i.e. a whiter pixel signal indicating a higher and whiter luminance than does the reference pixel signal, is outputted.

Further, in the “PIXEL-1”, the images of the bright objects A and B are not present during either the exposure period or the counter-exposure period, and only an image of a background that is darker than the bright objects A and B is present. In this case, in the “PIXEL-1”, the quantity of stored electrons is not relatively large during the counter-exposure period, and the quantity of stored holes is not relatively large during the exposure period; therefore, the quantity of electrons that are stored in the “PIXEL-1” during the readout period is 0 in total. That is, in the “PIXEL-1”, the reference pixel signal, which represents a case where no electric charge is stored in the charge storage region, is detected.

As noted above, in the example shown in FIG. 10A, in the “PIXEL-3” and the “PIXEL-4”, in which an image of a moving object is present and that differ in exposure amount between the counter-exposure period and the exposure period, pixel signals that are more positive or negative than the reference pixel signal are detected. That is, a pixel signal that is detected by the signal detection circuit 14 varies from the reference pixel signal, and a pixel signal indicating the presence of the moving object is detected. Further, in each of the “PIXEL-1” and the “PIXEL-2”, in which the image of the moving object is not present, the reference pixel signal is detected. That is, in the “PIXEL-1” and the “PIXEL-2”, pixel signals indicating the presence of the moving object are not detected. In this way, the signal processing circuit 120 can detect the moving object based on the pixel signals.

Further, this is not limited to a case where a bright object moves, but can be applied to a dark moving object, a moving object that is neither bright nor dark, or an object that entails a luminance change without moving. For example, in the case of a dark moving object, the dark moving object makes a luminance difference from the background, as the dark moving object moves while hiding the background. Therefore, the luminance difference makes a difference between the quantity of electric charge that is stored during the counter-exposure period and the quantity of electric charge that is stored during the exposure period, making it possible to detect the dark moving object. For example, in the case of a bright background and a moving object that is darker than the background, a pixel signal that is more positive (whiter) than the reference pixel signal is detected in a pixel to which the moving object has yet to move, and a pixel signal that is more negative (blacker) than the reference pixel signal is detected in a pixel to which the moving object has moved.

Although FIG. 10A is expressed as a schematic view of four pixels for simplicity, there may be a larger number of pixels in actuality, and depending on the timings of the exposure period and the counter-exposure period, signals that are similar to those detected in the “PIXEL-3” and the “PIXEL-4” may be detected in a plurality of pixels, or signals that are similar to those detected in the “PIXEL-3” and the “PIXEL-4” may be detected in pixels that are not adjacent to each other but a short distance away from each other.

FIG. 10B shows an example of a case where a bright ball object C is moving at high speed and such a ball object C is detected with the imaging device 100. As shown in FIG. 10B, an image of the ball object C moves across a plurality of pixels during each of the counter-exposure and exposure periods. Therefore, in the pixels-1, 2, 3, 7, 8, and 9 through which the image of the ball object C has passed during the counter-exposure period, pixel signals that are more negative (blacker) than the reference pixel signal are detected, and in the pixels-4, 5, 6, 10, 11, and 12 through which the image of the ball object C has passed during the exposure period, pixel signals that are more positive (whiter) than the reference pixel signal are detected. Further, in this case, the speed of the ball object C, which is a moving object, can be calculated by the signal processing circuit 120 or other circuits calculating the lengths of the exposure period and the counter-exposure period and the number of pixels in which signals that are more positive or negative than the reference pixel signal have been detected.

FIG. 10C shows an example of a case where the bright ball object C is moving at lower speed than it is in FIG. 10B. As shown in FIG. 10C, in a case where the ball object C is moving at low speed, an image of the ball object C can be present in the same pixels-2 and 8 during the exposure period and the counter-exposure period. In the pixels-1 and 7 in which the image of the ball object C was present only during the counter-exposure period, pixel signals that are more negative (blacker) than the reference pixel signal are detected, and in the pixels-3 and 9 in which the image of the ball object C was present only during the exposure period, pixel signals that are more positive (whiter) than the reference pixel signal are detected. Meanwhile, in pixels in which the image of the ball object C was present during both the counter-exposure period and the exposure period, pixel signals that are equal to the reference signal are outputted. Thus, there is a case where only a contour portion of the ball object C, which is a moving object, is detected as a pixel signal that is more positive or negative than the reference pixel signal.

Further, according to the foregoing description, in a pixel in which an image of a moving object is present, a pixel signal that is more positive or negative than the reference pixel signal is detected by the signal detection circuit 14; however, in generating a detection signal, the signal processing circuit 120 may set a threshold that is more positive or negative than the reference signal. For example, in a case where the signal processing circuit 120 generates a detection signal indicating black with a pixel signal less than or equal to the threshold, a pixel in which a bright moving object is present before moving can be confirmed as black output, and furthermore, a pixel in which the bright moving object is present after having moved can be confirmed as white output. Furthermore, a gradation can be provided toward even whiter output, and this makes it easier to determine not only that the moving object is bright but also how bright the moving object is. Further, the threshold may be set against a pixel signal that is detected by the signal detection circuit 14. For example, in a case where holes are stored as positive charge in the charge storage region during the exposure period and the potential of the charge storage region is less than the threshold, the signal detection circuit 14 outputs a pixel signal corresponding to the threshold. This makes it possible to reduce processing in the signal processing circuit 120. In a case where electric charge that is stored in the charge storage region during the counter-exposure period and electric charge that is stored in the charge storage region during the exposure period are opposite in polarity to each other and electrons are stored in the charge storage region during the exposure period and in a case where the potential of the charge storage region is greater than the threshold, the signal detection circuit 14 outputs a pixel signal corresponding to the threshold. Such a threshold can be set by the magnitude of the power supply voltage VDD and the characteristics of the signal detection transistor 24. Further, the quantity of electric charge that is stored until the threshold is reached can be adjusted by adjusting the reset voltage Vr.

Further, instead of the signal detection circuit 14 detecting a pixel signal that is more positive or negative than the reference pixel signal, the signal processing circuit 120 may generate a detection signal corresponding to the absolute value of a difference between the reference pixel signal and a pixel signal detected by the signal detection circuit 14. In the case of a dark background and a bright moving object, a pixel in which an image of the moving object is present before moving is relatively black, and a pixel in which the image of the moving object is present after having moved is relatively white; on the other hand, in the case of a bright background and a dark moving object, a pixel in which an image of the moving object is present before moving is relatively white, and a pixel in which the image of the moving object is present after having moved is relatively black. Therefore, the presence of a moving object can be indicated even by a detection signal corresponding to the absolute value of a difference between the reference pixel signal and a pixel signal detected by the signal detection circuit 14.

Further, each pixel 10 may be provided with a visible-light RGB (red, green, blue) and/or near-infrared filter as an optical filter. This makes it possible to determine, for example, what color the moving object is.

Further, in normal imaging driving such as that described with reference to FIG. 7, there is no counter-exposure period during which electric charge that is opposite in polarity to that which is stored in the charge storage region during the exposure period is stored in the charge storage region. Therefore, in the case of imaging of an object that is not the moving object and a background, electric charge cannot be canceled out, and a signal simply corresponding to the brightness of an object is only detected regardless of whether the object is the moving object, with the result that the moving object cannot be detected.

### Output from Signal Processing Circuit

Next, an example of output of a detection signal that is generated by the signal processing circuit 120 is described. In the moving object detection driving, the generation and output of a detection signal by the signal processing circuit 120 can be performed in various ways. For example, the signal processing circuit 120 outputs the detection signal thus generated to at least either the drive control circuit 130 or the image processor 300.

For example, the signal processing circuit 120 may generate, based on a pixel signal detected by the signal detection circuit 14, a detection signal indicating whether a moving object is present in a range of imaging of the imaging device 100. For example, the signal processing circuit 120 generates, based on whether there is a pixel 10 that outputs a pixel signal differing to a predetermined or higher degree from the reference pixel signal, a detection signal indicating whether the presence of the moving object has been detected. In this case, the detection signal is outputted to the drive control circuit 130 and used in control of drive of the imaging device 100. Further, in this case, the signal processing circuit 120 may or may not output the detection signal to a device external to the imaging device 100 such as the image processor 300. Further, in a case where the moving object is not present in the range of imaging of the imaging device 100, the signal processing circuit 120 may not generate a detection signal.

Further, the signal processing circuit 120 may identify the shape of the moving object based on the pixel signal and generate and output a detection signal containing information indicating a result of the identification. For example, the signal processing circuit 120 retains a logical model of outputting the shape of an object by inputting a pixel signal of each pixel 10 and uses the logical model to generate and output a detection signal containing information indicating what shape the moving object is. The logical model is, for example, a learned logical model mechanically learned using training data associating the shape of a known object with a pixel signal of each pixel 10. This allows the signal processing circuit 120, for example, to identify whether the moving object is in the shape of a ball, in the shape of an automobile, or in the shape of a human and output a result of the identification. This makes it possible to reduce the processing load in post-processing and reduce the volume of saved data. This also enables considerations for privacy.

Further, the signal processing circuit 120 may generate and output, based on a pixel signal detected by the signal detection circuit 14, a detection signal containing image data. In a case where the moving object is detected, image data contains information indicating a portion (pixel) where the amount of exposure during the exposure period and the amount of exposure during the counter-exposure period are different from each other. Further, a detection signal containing image data may be generated in a plurality of patterns as follows.

For example, in generating image data, the signal processing circuit 120 directly uses a pixel signal inputted to the signal processing circuit 120. That is, the signal processing circuit 120 may generate and output a detection signal containing image data representing the pixel value of the normal number of tones constituted by data representing all effective pixels in the imaging device 100.

Further, for example, the signal processing circuit 120 may generate and output a detection signal containing binarized or ternarized image data. In a case where the binary image data is generated, for example, binarization is performed by using, as a threshold, the value of the reference pixel signal, which corresponds to the reset level, or a value obtained by adding a predetermined offset to the reference pixel signal. Further, in a case where the ternarized image data is generated, for example, ternarization is performed with two thresholds set by directly using the value of the reference pixel signal, which corresponds to the reset level, or adding a predetermined offset. The process of binarization or ternarization may be performed by the signal processing circuit 120 converting pixel signals AD converted with the normal number of tones with reference to a conversion table or other tables or may be performed by the column signal processing circuits 37 AD-converting pixel signals with two tones or three tones. This makes it possible to reduce power consumption, reduce the processing load, and reduce the volume of saved images.

Further, for example, the signal processing circuit 120 generate and output a detection signal containing image data from which information indicating an object other than the moving object is decimated. For example, a pixel signal having a value falling within a predetermined range including the value of the reference pixel signal, which corresponds to the reset level, is not used by the signal processing circuit 120 to generate the image data, as such a pixel signal is information indicating an object other than the moving object. Further, for example, by identifying a pixel whose pixel signal differs by predetermined or greater magnitude from the reference pixel signal, the signal processing circuit 120 may identify a pixel in which an image of the moving object is present and generate the image data with decimation of a pixel other than the pixel in which the image of the moving object is present or a pixel other than pixels in a rectangular region including the pixel in which the image of the moving object is present. This makes it possible to reduce the processing load in post-processing and reduce the volume of saved images.

Further, a detection signal containing information or image data indicating a result of the aforementioned identification may be generated and outputted by the signal processing circuit 120 only in a case where the presence of the moving object has been detected based on a pixel signal. In this case, in a case where the presence of the moving object has not been detected, the signal processing circuit 120 either generates a detection signal indicating only information indicating that the moving object is not present, or does not generate a detection signal.

Further, the method of generation and output of a detection signal by the signal processing circuit 120 may be switched among the aforementioned methods upon receipt of a selection from a user.

### Drive Mode Switching

Next, switching between the drive modes of the imaging device 100 by the drive control circuit 130 is described. The drive control circuit 130 controls the imaging device 100 so that the imaging device 100 switches between performing moving object detection driving and performing normal imaging driving. Switching between the moving object detection driving and the normal imaging driving can be done simply by changing a pattern of a bias voltage that is applied to the photoelectric converter 13 and can therefore be done at high speed. For example, the drive control circuit 130 can select, for each frame, whether to drive the imaging device 100 in the moving object detection driving or the normal imaging driving.

For example, in a case where the signal processing circuit 120 detects a moving object while the imaging device 100 is operating in the moving object detection driving, the drive control circuit 130 switches the drive mode from the moving object detection driving to the normal imaging driving. In this case, the voltage supply circuit 32 does not apply the first voltage between the pixel electrode 11 and the counter electrode 12 but applies the fourth voltage between the pixel electrode 11 and the counter electrode 12 during a one-frame period subsequent to a one-frame period in the moving object detection driving. This makes it possible to reduce power consumption in post-processing in the moving object detection driving and, even in a surveillance application, enables considerations for privacy. Meanwhile, once the moving object is detected, the imaging device 100 switches to the normal imaging driving and can output a more detailed image.

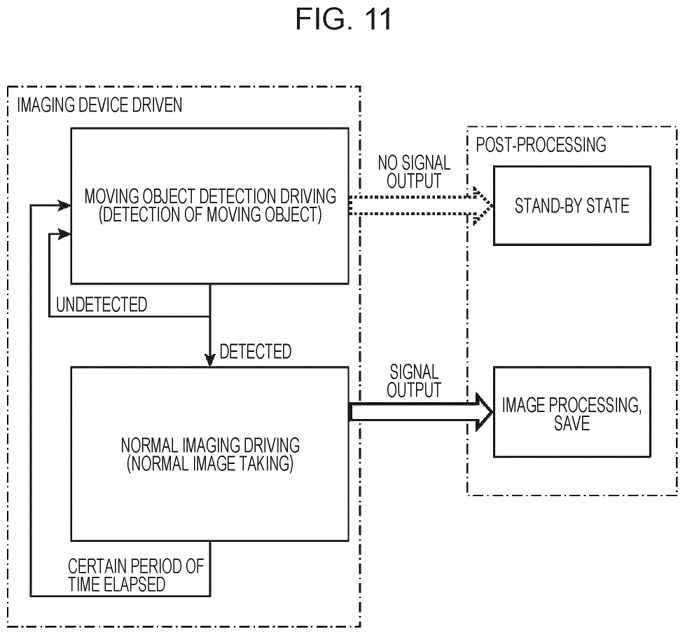

FIG. 11 is a diagram for explaining a first example of drive mode switching in the imaging device 100 according to the present embodiment. As shown in FIG. 11, in the first example, first, the drive control circuit 130 causes the imaging device 100 to perform the moving object detection driving. In this occasion of moving object detection driving, no detection signal is outputted to a device external to the imaging device 100. For example, the signal processing circuit 120 does not output a detection signal to a device external to the imaging device 100. Therefore, the image processor 300 or other devices that perform post-processing on output from the imaging device 100 do not need to perform image processing or other processes and, for example, are in a stand-by state. This makes it possible to reduce power consumption in post-processing. This also makes it possible to reduce the volume of saved images.

Further, in the moving object detection driving, the signal processing circuit 120 detects, based on a pixel signal, whether the moving object is present in the range of imaging of the imaging device 100. For example, the signal processing circuit 120 detects the presence of the moving object in a case where there is a pixel that outputs a pixel signal differing to a certain or higher degree from the reference signal. For example, the signal processing circuit 120 generates a detection signal containing no image data and indicating whether the presence of the moving object has been detected in the range of imaging and outputs the detection signal to the drive control circuit 130. Further, the signal processing circuit 120 generates a detection signal only in a case where the moving object has been detected, and does not need to generate a detection signal in a case where the moving object has not been detected. The drive control circuit 130 continues the moving object detection driving in a case where the moving object has not been detected by the signal processing circuit 120. Meanwhile, the drive control circuit 130 switches the drive mode from the moving object detection driving to the normal imaging driving in a case where the moving object has been detected by the signal processing circuit 120. In the normal imaging driving, a signal containing image data is outputted to a device external to the imaging device 100. For example, in the normal imaging driving, the image processor 300 or other devices that perform post-processing on output from the imaging device 100 perform image processing, saves, or other processes on the image data outputted from the imaging device 100.

The drive control circuit 130 switches the drive mode from the normal imaging driving to the moving object detection driving after a predetermined period of time has elapsed since the imaging device 100 performed the normal imaging driving. This enables the camera system 1 as a whole to be driven with low power consumption. Further, after switching to the moving object detection driving, the aforementioned operation is performed again.

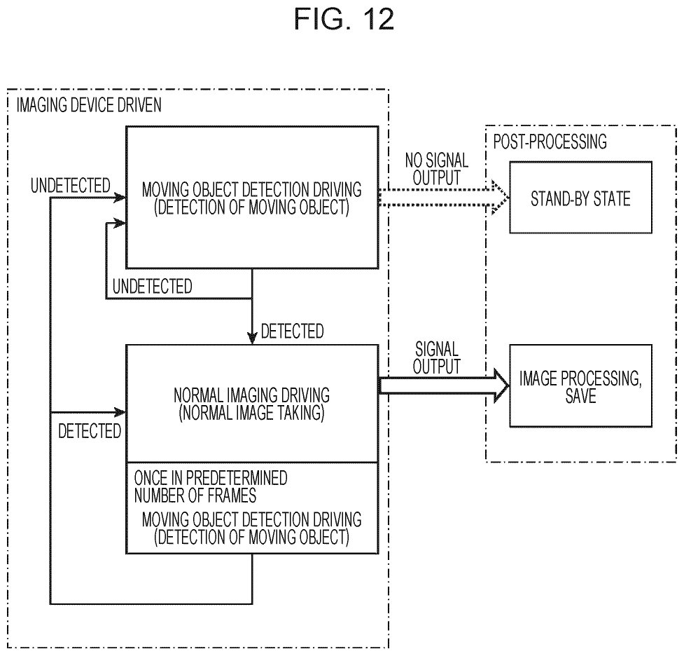

Further, while causing the imaging device 100 to perform the normal imaging driving, the drive control circuit 130 may cause the imaging device 100 to switch to performing the moving object detection driving. FIG. 12 is a diagram for explaining a second example of drive mode switching in the imaging device 100 according to the present embodiment. The second example shown in FIG. 12 is the same as the aforementioned first example in that, first, the drive control circuit 130 causes the imaging device 100 to perform the moving object detection driving and, in a case where the moving object has been detected, causes the imaging device 100 to switch to performing the normal imaging driving. As shown in FIG. 12, in the second example, the drive control circuit 130 causes the imaging device 100 to perform the moving object detection driving once in a predetermined number of frames such as ten frames in the normal imaging driving. The drive control circuit 130 continues the normal imaging driving in a case where the moving object has been detected by the signal processing circuit 120 in the moving object detection driving during the normal imaging driving. Meanwhile, the drive control circuit 130 switches the drive mode from the normal imaging driving to the moving object detection driving in a case where the moving object has been detected by the signal processing circuit 120 in the moving object detection driving during the normal imaging driving. In this case, detection of the moving object is performed even during the normal imaging driving, switching to the moving object detection driving is done in a case where the moving object is no longer present. This makes it possible to reduce power consumption in post-processing and also reduce the volume of saved images.

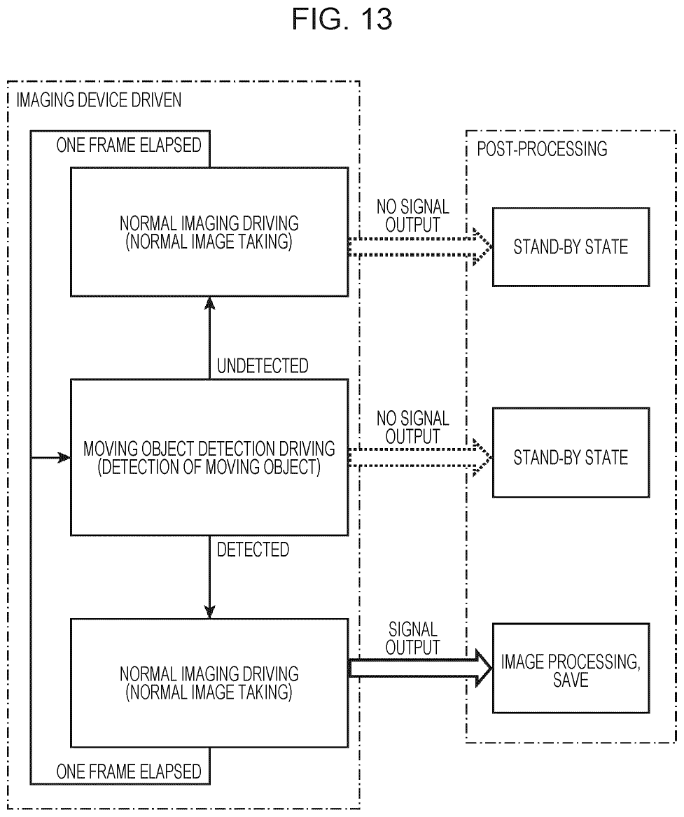

Further, the drive control circuit 130 may switch between the moving object detection driving and the normal imaging driving regardless of whether the moving object is being detected. FIG. 13 is a diagram for explaining a third example of drive mode switching in the imaging device 100 according to the present embodiment. As shown in FIG. 13, in the third example, the drive control circuit 130 causes the imaging device 100 to alternately perform the moving object detection driving and the normal imaging driving every one frame. In a case where the signal processing circuit 120 has detected the moving object in the moving object detection driving, a signal containing image data or other data is outputted to a device external to the imaging device 100 in the subsequent normal imaging driving. The image processor 300 or other devices that perform post-processing on output from the imaging device 100 perform image processing, saves, or other processes on the image data outputted from the imaging device 100.

Meanwhile, in a case where the signal processing circuit 120 has not detected the moving object in the moving object detection driving, no signal is outputted to a device external to the imaging device 100 in the subsequent normal imaging driving. For example, the signal processing circuit 120 does not output image data based on a pixel signal that is detected in the normal imaging driving. Therefore, the image processor 300 or other devices that perform post-processing on output from the imaging device 100 do not need to perform image processing or other processes and, for example, are in a stand-by state. This makes it possible to reduce power consumption in post-processing and also reduce the volume of saved images.

Further, the number of times the moving object detection driving and the normal imaging driving are alternately performed is not limited to one frame, and the moving object detection driving and the normal imaging driving may be alternately performed every more than one frame. Further, the numbers of frames of moving object detection driving and normal imaging driving that are alternately performed may be different from each other.

Although, in the foregoing first to third examples, no detection signal is outputted to a device external to the imaging device 100 in the moving object detection driving, this is not intended to impose any limitation. For example, as described in section “Output from Signal Processing Circuit” above, information indicating that the moving object is not present, information indicating a result of identification, or a detection signal containing image data may be outputted to a device external to the imaging device 100 in the moving object detection driving.

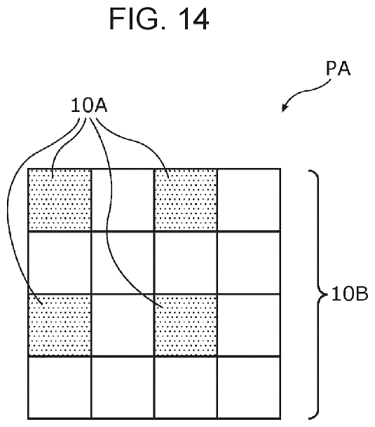

Further, although the moving object detection driving and the normal imaging driving may be performed in all pixels 10, all pixels 10 do not need to be driven in a case where the moving object detection driving is performed. FIG. 14 is a diagram for explaining pixels 10 in which the moving object detection driving is performed and pixels 10 in which the normal imaging driving is performed. For example, the pixel array PA, which is constituted by the plurality of pixels 10, includes a first pixel group 10A in which the moving object detection driving is performed and a second pixel group 10B in which the normal imaging driving is performed. In the example shown in FIG. 14, the first pixel group 10A is a pixel group in the pixel array PA from which even-numbered rows and columns have been decimated. Further, the second pixel group 10B is a pixel group constituted by all pixels 10 of the pixel array PA. That is, the first pixel group 10A includes a smaller number of pixels than does the second pixel group 10B. This makes it possible to reduce the number of pixels that are driven in the moving object detection driving, thus making it possible to reduce power consumption.

Further, in the moving object detection driving, the signal processing circuit 120 may limit a pixel region in which to perform detection of the moving object. For example, in the case of imaging of an object such as a light whose luminance varies, a flag flapping in the wind, or other objects, there can be a difference between the amount of exposure during the exposure period and the amount of exposure during the counter-exposure period as in the case of the moving object, with the result that a pixel signal of a level similar to that of a pixel signal that is detected in the case of imaging of the moving object may be detected. In this case, a pixel region in which the moving object is to be detected may be set with the preliminary exclusion of a pixel region in which an object such as a light whose luminance varies, a flag flapping in the wind, or other objects are present. In this way, in the moving object detection driving, the signal processing circuit 120 can generate a detection signal pertaining to the moving object by, without detecting, as the moving object, an object that is not actually moving or other objects, detecting the moving object actually moving. Further, for example, the signal processing circuit 120 may detect whether the moving object is present, with the exclusion of, from the pixel region in which the moving object is to be subjected, a pixel 10 that outputs a pixel signal differing to a predetermined or higher degree from the reference pixel signal across a predetermined number of frames.

### Other Embodiments

While the foregoing has described an imaging device and a camera system according to the present disclosure with reference to embodiments, the present disclosure is not intended to be limited to these embodiments.

Further, although, in the foregoing embodiment, the signal detection transistor 24, the address transistor 26, and the reset transistor 28 are N-channel MOSFETs, this is not intended to impose any limitation. The signal detection transistor 24, the address transistor 26, and the reset transistor 28 may be P-channel MOSFETs. All these do not need to be uniformly either N-channel MOSFETs or P-channel MOSFETs. Further, the signal detection transistor 24 and/or the address transistor 26 may be not a field-effect transistor but another transistor such as a bipolar transistor.

Further, although, in the foregoing embodiment, the exposure period and the counter-exposure period during a one-frame period are one continuous period, this is not intended to impose any limitation. For example, either the exposure period or the counter-exposure period may be divided by the non-exposure period being present in the middle thereof.

Further, although the foregoing embodiment has illustrated an example in which the signal processing circuit 120 detects a moving object that simply makes a great movement, this is not intended to impose any limitation. In addition to detecting a moving object that simply makes a great movement, the signal processing circuit 120 can similarly detect a vibrating object, a flapping object such as a flag, and an object such as a traffic light that makes a luminance change. Further, the contours or other features of an object can also be detected by shifting an imaging region by moving the imaging device 100 instead of moving the object to be imaged.

Further, although, in the foregoing embodiment, both the exposure period and the counter-exposure period are present within a one-frame period in the moving object detection driving, this is not intended to impose any limitation. For example, only either the exposure period or the counter-exposure period may be present within a one-frame period, and the signal processing circuit 120 may generate, based on a pixel signal that is detected in a frame in which the exposure period is present and a pixel signal that is detected in a frame in which the counter-exposure period is present, a detection signal pertaining to the moving object. The pixel signals that are detected separately in each of the frames are temporarily stored, for example, in a frame memory.

Further, the camera system 1 and the imaging device 100 do not need to include all constituent elements described in the foregoing embodiment and may be composed solely of constituent elements for achieving the intended operation.

Further, in the foregoing embodiment, a process that is executed by a specific processor such as the signal processing circuit 120 and the drive control circuit 130 may be executed by another processor. Further, the order of a plurality of processes may be changed, or the plurality of processes may be executed in parallel.

Further, general or specific embodiments may be implemented as a system, a device, a method, an integrated circuit, a computer program, or a computer-readable storage medium such as a CD-ROM. Further, general or specific embodiments may be implemented as a system, a device, a method, an integrated circuit, a computer program, a storage medium, or any selective combination thereof.

For example, the present disclosure may be implemented as the camera system or the imaging device of the foregoing embodiment, may be implemented as a processing circuit for use in the imaging device having functions of the signal processing circuit, the drive control circuit, or other circuits of the foregoing embodiment, may be implemented as an imaging method of the imaging device that the signal processing circuit, the drive control circuit, or other circuits of the foregoing embodiment perform, may be implemented as a program for causing a computer to execute such an imaging method, or may be implemented as a computer-readable non-transitory storage medium having such a program stored thereon.

In addition, various modifications conceived of by persons skilled in the art are encompassed in the scope of the present disclosure. Further, constituent elements of different embodiments may be arbitrarily combined without departing from the scope of the present disclosure.

An imaging device or other devices according to the present disclosure are applicable, for example, to an image sensor or other sensors. Further, an imaging device or other devices according to the present disclosure can be used in a camera for medical use, a camera for use in a robot, a security camera, a camera that is mounted on a vehicle for use, or other cameras.

What is claimed is:

1. An imaging device for taking an image of an object, the imaging device comprising:
a photoelectric converter including a first electrode, a second electrode facing the first electrode, and a photoelectric conversion layer located between the first electrode and the second electrode;
a voltage supply circuit that applies a voltage between the first electrode and the second electrode;
a signal detection circuit that detects a first signal based on electric charge generated by the photoelectric converter; and
a signal processing circuit, wherein
in a first frame period including a first period and a second period different from the first period, the voltage supply circuit applies a first voltage between the first electrode and the second electrode during the first period and applies a second voltage between the first electrode and the second electrode during the second period, the second voltage being opposite in polarity to the first voltage, and
the signal processing circuit generates, based on the first signal detected by the signal detection circuit in the first frame period, a second signal pertaining to a moving object moving in the first frame period.

2. The imaging device according to claim 1, wherein
the signal processing circuit generates image data based on the first signal, and
the signal processing circuit generates and outputs, as the second signal, a signal containing information indicating a portion in the image data where an amount of exposure in the image data during the first period and an amount of exposure in the image data during the second period are different from each other.

3. The imaging device according to claim 1, wherein
the signal processing circuit detects, based on the first signal, whether the moving object is present in the image, and
in a case where, in the first frame period, the signal processing circuit does not detect presence of the moving object in the image, the signal processing circuit does not generate the second signal.

4. The imaging device according to claim 1, wherein
in a third period subsequent to the first period and the second period, the voltage supply circuit applies, between the first electrode and the second electrode, a third voltage that is a voltage between the first voltage and the second voltage, and
the signal detection circuit outputs the first signal in the third period.

5. The imaging device according to claim 4, wherein the photoelectric converter has such a photocurrent characteristic that a difference between a dark-time current and a bright-time current that flow through the photoelectric converter when the third voltage is applied between the first electrode and the second electrode is less than a difference between a dark-time current and a bright-time current that flow through the photoelectric converter when the first voltage is applied between the first electrode and the second electrode and a difference between a dark-time current and a bright-time current that flow through the photoelectric converter when the second voltage is applied between the first electrode and the second electrode.

6. The imaging device according to claim 1, wherein
when the second voltage is applied between the first electrode and the second electrode, a magnitude of the first signal that is detected by the signal detection circuit and inputted to the signal processing circuit increases by light incident on the photoelectric converter, and
an absolute value of the second voltage is greater than an absolute value of the first voltage.

7. The imaging device according to claim 6, wherein the second period is shorter than the first period.

8. The imaging device according to claim 1, wherein the imaging device is driven by a global shutter method in which an exposure period is defined by changing the voltage that the voltage supply circuit applies between the first electrode and the second electrode.

9. The imaging device according to claim 1, further comprising a charge accumulator in which the electric charge is stored, wherein
in the second period, a positive charge of the electric charge is stored in the charge accumulator, and
in a case where a potential of the charge accumulator is less than a threshold, the signal detection circuit outputs the first signal corresponding to a value of the threshold.

10. The imaging device according to claim 1, wherein
the signal processing circuit detects, based on the first signal, whether the moving object is present in the image, and
in a case where presence of the moving object in the image is detected by the signal processing circuit in the first frame period, the voltage supply circuit does not apply the first voltage between the first electrode and the second electrode and applies a fourth voltage between the first electrode and the second electrode during a one-frame period subsequent to the first frame period, the fourth voltage being identical in polarity to the second voltage.

11. The imaging device according to claim 1, wherein the signal processing circuit identifies a shape of the moving object based on the first signal and generates and outputs, as the second signal, a signal containing information indicating the shape.

12. The imaging device according to claim 1, wherein the signal processing circuit generates and outputs, as the second signal, a signal containing binarized or ternarized image data.

13. The imaging device according to claim 1, wherein the signal processing circuit generates and outputs, as the second signal, a signal containing image data from which information indicating an object other than the moving object is decimated.

14. The imaging device according to claim 1, further comprising a drive control circuit that controls driving of the imaging device,
wherein the drive control circuit controls the imaging device so that the imaging device switches between performing (i) moving object detection driving in which in the first frame period, the signal processing circuit generates the second signal pertaining to the moving object and performing (ii) normal imaging driving in which in a second frame period, the voltage supply circuit does not apply the first voltage between the first electrode and the second electrode and applies a fourth voltage between the first electrode and the second electrode, the fourth voltage being identical in polarity to the second voltage.

15. The imaging device according to claim 14, wherein
the signal processing circuit detects, based on the first signal, whether the moving object is present in the image, and
in a case where presence of the moving object in the image is detected by the signal processing circuit while the imaging device is performing the moving object detection driving, the drive control circuit switches from the moving object detection driving to the normal imaging driving.

16. The imaging device according to claim 15, wherein the drive control circuit switches from the normal imaging driving to the moving object detection driving after a predetermined period of time has elapsed since switching to the normal imaging driving was done.

17. The imaging device according to claim 14, wherein
the signal processing circuit detects, based on the first signal, whether the moving object is present in the image, and
in a case where presence of the moving object is detected by the signal processing circuit while the imaging device is performing the moving object detection driving, the drive control circuit causes the moving object detection driving and the normal imaging driving to be repeatedly performed until the presence of the moving object is no longer detected by the signal processing circuit.

18. The imaging device according to claim 14, further comprising a plurality of pixels, wherein
each of the plurality of pixels includes the photoelectric converter and the signal detection circuit,
the plurality of pixels include a first pixel group in which the moving object detection driving is performed and a second pixel group in which the normal imaging driving is performed, and
the number of pixels in the first pixel group is less than the number of pixels in the second pixel group.

19. The imaging device according to claim 14, wherein in the moving object detection driving, the second signal is not outputted to a device external to the imaging device.

20. A camera system comprising:
the imaging device according to claim 1; and
a lighting device that emits light containing near infrared radiation.
